(19) United States
(12) Patent Application Publication
(10) Pub. No.: US 2026/0359134 A1
(43) Pub. Date: Nov. 12, 2026

(54) Using A Cloud Management Enclave To Isolate A Workload Execution Enclave From A Facilities Management Enclave That Regulates Facilities Associated With The Workload Execution Enclave

(71) Applicant: Oracle International Corporation, Redwood Shores, CA (US)

(72) Inventors: Ashokkumar Kannan, Chennai (IN); Modin Bude Shaik, Bangalore (IN); Heyang Chen, Newark, CA (US); Joshua Horwitz, Centreville, VA (US)

(73) Assignee: Oracle International Corporation, Redwood Shores, CA (US)

(21) Appl. No.: 19/220,707

(22) Filed: May 28, 2025

Related U.S. Application Data
(60) Provisional application No. 63/771,142, filed on Mar. 13, 2025.

(51) Int. Cl. G06F 9/50; G06F 11/30

(52) U.S. Cl. CPC G06F 9/505; G06F 9/5072; G06F 11/3006; G06F 11/3058

(57) ABSTRACT

A workload execution enclave receives telemetry data from multiple sensors. The workload execution enclave transmits the telemetry data to a monitoring application within a cloud management enclave. The monitoring application performs monitoring operations related to the workload execution enclave based on the received telemetry data. The cloud management enclave processes the telemetry data to generate processed telemetry data. The cloud management enclave transmits the processed telemetry data to a facility control system located in a facilities management enclave. The facility control system regulates facilities associated with the workload execution enclave according to the processed telemetry data.

### INCORPORTION BY REFERENCE; DISCLAIMER

The following application is hereby incorporated by reference: application no. 63/771,142 filed on Mar. 13, 2025, entitled “Using a Cloud Management Enclave to Isolate a Workload Execution Enclave from a Facilities Management Enclave that Regulates Facilities Associated with the Workload Execution Enclave”. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates generally to computer network security, and more particularly to systems and methods for implementing secure networks for segregating and protecting sensitive network resources.

### BACKGROUND

The field of computer network security has evolved significantly in response to cyber threats and the need to protect digital assets. Traditional security approaches rely on perimeter defenses and access controls, which have proven inadequate against various threats and challenges in distributed computing. These conventional methodologies often suffer from limitations, including inflexible security boundaries, limited awareness of context, and insufficient control granularity, resulting in policies that either unnecessarily restrict legitimate activities or create potential vulnerabilities.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system with multiple network enclaves interconnected for telemetry data processing and facilities management in accordance with one or more embodiments;

FIG. 2 illustrates an example set of operations for processing telemetry data using workload execution enclave and a cloud management enclave in accordance with one or more embodiments;

FIG. 3 illustrates an example set of operations for detecting and responding to coolant leak events, including transmitting notifications between enclaves and implementing appropriate facility regulation measures in accordance with one or more embodiments; and

FIG. 4 illustrates an example set of operations for monitoring workload spikes and implementing responsive cooling adjustments in accordance with one or more embodiments;

FIG. 5 illustrates an example operational flows for multi-enclave cloud infrastructure facilities management in accordance with one or more embodiments;

FIGS. 6-9 are block diagrams illustrating patterns for implementing a cloud infrastructure as a service system in accordance with one or more embodiments;

FIG. 10 is a high-level diagram of a distributed environment showing a virtual or overlay cloud network hosted by a cloud service provider infrastructure in accordance with one or more embodiments;

FIG. 11 depicts a simplified architectural diagram of the physical components in the physical network within CI in accordance with one or more embodiments;

FIG. 12 depicts a simplified block diagram of a physical network provided by a CI in accordance with one or more embodiments;

FIG. 13 depicts a data center containing rows of compute racks and network racks, with the network racks implementing a network fabric in accordance with one or more embodiments; and

FIG. 14 is a hardware system in accordance with one or more embodiments.

### INTRODUCTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” generally refers to a service that is made available on demand, via scalable cloud infrastructure, typically over the internet or a private network, and managed by an external or in-house cloud provider (CP). The term “cloud infrastructure” (CI) generally refers to hardware and software components that provide computing, storage, and networking resources to deliver cloud services. There are various types or models of cloud services including Software-as-a-Service (SaaS), Platform-as-a-Service (PaaS), Infrastructure-as-a-Service (IaaS), Function-as-a-Service (FaaS), and others.

In a typical IaaS model, a CP provides virtualized and bare metal computing resources like servers, storage, and networking in a CP-operated data center. The CP is responsible for managing and maintaining the CI; the responsibilities span across multiple domains, such as operations, security, scalability, and compliance. Customers access the cloud services over the public Internet. Customers can use the CP CI to build their own customizable virtual or overlay networks and deploy customer resources. In other models, a CP provides similar virtualized and bare metal computing resources but in a customer-operated data center, which may include the customer's own CI. Customers access the CP CI and the customer CI over a private network. The combination of cloud services of the CP and the customer may be referred to as a “hybrid cloud.” In some cases, customers can serve as the CP's partner and sell the CP cloud services to further downstream customers. In yet other models, a first CP provides its virtualized and bare metal computing resources like servers, storage, and networking in the first CP's data center. A second CP provides its virtualized and bare metal computing resources also in the first CP's data center. A dedicated private network connects the CI of the two CPs. The combination of cloud services of the both CPs may be referred to as a “hybrid cloud.” In yet other models, a CP initially provisions CI to a customer, and then hands over all or a subset of the responsibilities associated with managing and maintaining the CI. For example, the customer may be primarily responsible for duties such as provisioning, repair, and maintenance of compute instances, while the CP retains other duties such as network management. Still other models may be used.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. FACILITIES MANAGEMENT SYSTEM
3. FACILITIES MANAGEMENT METHOD
4. DETECTING AND RESPONDING TO COOLANT LEAKS
5. MONITORING AND RESPONDING TO WORKLOAD SPIKES
6. EXEMPLARY OPERATIONAL FLOWS FOR MULTI-ENCLAVE CLOUD INFRASTRUCTURE FACILITIES MANAGEMENT
   A. OPERATIONAL FLOW FOR COOLANT LEAK DETECTION
   B. OPERATIONAL FLOW FOR WORKLOAD SPIKE MANAGEMENT
7. PRACTICAL APPLICATIONS, ADVANTAGES & IMPROVEMENTS
8. EXAMPLES OF CLOUD INFRASTRUCTURE
9. EXAMPLES OF CLOUD NETWORKS
10. EXAMPLE NETWORK FABRICS
11. HARDWARE OVERVIEW
12. MISCELLANEOUS; EXTENSIONS

### 1. GENERAL OVERVIEW

One or more embodiments execute a cloud management enclave that isolates a workload execution enclave from a facilities management enclave that regulates facilities associated with the workload execution enclave. A workload execution enclave receives telemetry data from multiple sensors associated with devices (computing devices executing workloads, power devices, etc.) in a workload execution enclave. The telemetry data is transmitted from the workload execution enclave to a monitoring application located in a cloud management enclave. The monitoring application executes monitoring operations based on received telemetry data. The cloud management enclave processes the telemetry data to generate processed telemetry data. The processed telemetry data is transmitted from the cloud management enclave to a facility control system in a facilities management enclave. The facility control system regulates facilities associated with the workload execution enclave based on the processed telemetry data.

One or more embodiments implement security boundaries between operational domains. The workload execution enclave is restricted from transmitting certain types of communications directly to the facilities management enclave. A peering connection exists between the workload execution enclave and the cloud management enclave, while another peering connection exists between the cloud management enclave and the facilities management enclave. No peering connection exists between the workload execution enclave and the facilities management enclave. The multiple enclaves maintain separation of network fabrics, with no network fabric crossing multiple enclaves. In one embodiment, components in the workload execution enclave lack credentials for transmitting data to the facility control system in the facilities management enclave.

One or more embodiments establish controlled data flow pathways for telemetry information. Devices such as computing devices or power devices, in the workload execution enclave associate with sensors and baseboard management controllers. The baseboard management controllers receive telemetry data from sensors and transmit the data to monitoring applications. Alternately, the sensors are associated with other devices such as power devices. The workload execution enclave implements security policies allowing egress traffic while prohibiting ingress traffic. In one example, connections for external communication establish with the baseboard management controllers, not with sensors or computing devices themselves. The monitoring applications filter telemetry data by identifying state changes requiring control system notification while suppressing redundant updates.

One or more embodiments enhance telemetry data with contextual information. The monitoring applications enrich telemetry data with location data providing physical context for facility control system responses. In one embodiment, sensors or devices map to physical locations within data centers. The processed telemetry data includes information identifying relevant physical locations. In another embodiment, sensors or devices map to relevant facilities within the data centers. The monitoring application adds data identifying these relevant facilities before transmission to facility control systems.

One or more embodiments respond to operational conditions related to cooling system integrity. Coolant leak detection telemetry data collected by leak sensors couples to devices, such as computing devices, in workload execution enclaves. Leak detection sensors ensure prompt notification through structured communication channels between enclaves. The leak sensors transmit status information through the baseboard management controllers to the monitoring application for evaluation and appropriate facility response actions.

One or more embodiments manage thermal conditions based on computational workload demands. Power telemetry data collection occurs through sensors associated with graphics processing units. Increases in power consumption at the graphics processing units trigger cooling system responses when satisfying trigger criteria. The system then ramps up chillers and/or increases cooling of the chillers pumping liquid coolant to cold plates of the graphics processing units. Analysis of power consumption determines appropriate trigger criteria for the cooling system responses.

One or more embodiments described in this Specification and/or recited in the claims may not be included in this General Overview section.

### 2. FACILITIES MANAGEMENT SYSTEM

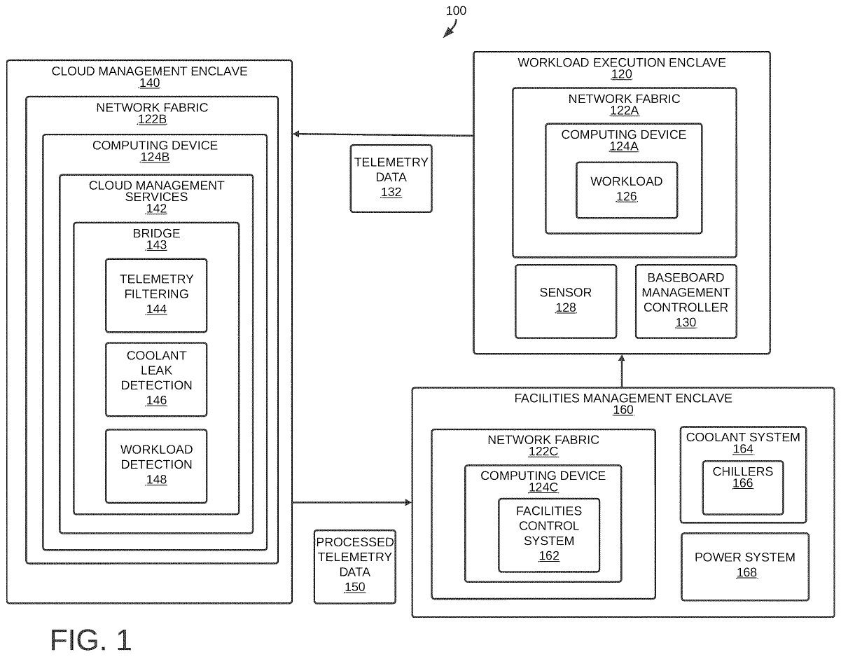

FIG. 1 illustrates a system 100 with multiple network enclaves interconnected for telemetry data processing and facilities management in accordance with one or more embodiments. As illustrated in FIG. 1, system 100 includes workload execution enclave 120, cloud management enclave 140, facilities management enclave 160, network fabric 122A, network fabric 122B, network fabric 122C, computing device 124A, computing device 124B, computing device 124C, workload 126, sensor 128, baseboard management controller 130, telemetry data 132, cloud management services 142, telemetry filtering 144, coolant leak detection 146, workload detection 148, processed telemetry data 150, facilities control system 162, coolant system 164, chillers 166, and power system 168.

In one or more embodiments, system 100 may include more or fewer components than the components illustrated in FIG. 1. The components illustrated in FIG. 1 may be local to or remote to the others. The components illustrated in FIG. 1 may be implemented in software and/or hardware. Components may be distributed over multiple applications and/or machines. Multiple components may be combined into one application and/or machine. Operations described with respect to one component may instead be performed by another component.

In an embodiment, system 100 represents a datacenter architecture implementing a multi-enclave security design for facilities management. System 100 establishes distinct security domains with controlled information flow between customer computing environments and facilities infrastructure. System 100 implements network enclaves to subdivide internal networks, establishing isolation between customer and cloud provider operations.

In an embodiment,, an “enclave” refers to a secure, isolated section of a network that is deliberately separated from the larger network infrastructure through specific security measures. These enclaves create logical or physical boundaries around sensitive resources, implementing isolation as a core security principle.

In an embodiment, network enclaves maintain isolation from the main network infrastructure, creating protective barriers around sensitive systems. Such implementations generally incorporate access control mechanisms, that include various security devices to regulate traffic flow. These architectures typically manage communication between protected network segments and external networks, permitting only essential, authenticated connections. Such enclave architectures have been predominantly deployed in high-security environments, including military networks, government agencies handling classified information, financial institutions, healthcare organizations with protected health information, and industrial control systems managing critical infrastructure. This isolation is achieved through a combination of physical separation, network segmentation, cryptographic protocols, and/or access control mechanisms that collectively form a security boundary around the enclave. The architecture enforces strict data flow controls between enclaves, allowing for secure communication channels while preventing unauthorized access or data leakage. Enclaves are configured with their own security policies, authentication requirements, and monitoring systems, enabling fine-grained protection tailored to the sensitivity of operations performed within the enclave. This multi-layered isolation approach ensures that compromises or risks in one enclave or in other network infrastructures do not propagate to other protected environments, thereby significantly enhancing the overall security posture of the system.

In an embodiment, network enclaves establish distinct security domains with controlled information flow between customer computing environments and facilities infrastructure. The architecture implements firm boundaries between different network segments through a combination of physical separation, network segmentation, access control mechanisms, and specialized protocols that collectively form security perimeters around sensitive resources. These enclaves maintain isolation from the main network infrastructure, creating protective barriers around sensitive systems while incorporating mechanisms that regulate traffic flow. Communication between protected network segments and external networks occurs only through essential, authenticated connections with security policies enforcing directional data flows. The multi-layered isolation approach ensures compromises in one enclave do not propagate to other protected environments, significantly enhancing the overall security posture through separation of network fabrics where no fabric crosses multiple enclaves.

In an embodiment, network enclave architecture establishes security boundaries between separate network fabrics belonging to the cloud service provider enclave and customer enclave, with each fabric terminating at its respective security boundary rather than traversing between domains. These boundaries function as enforcement points for security policies, traffic filtering, and access control mechanisms that permit only authorized communication flows. The dedicated connection between enclaves serves as a controlled communication channel with precise security parameters, operating through authenticated pathways while maintaining separation of administrative domains. Network fabric isolation prevents lateral movement of security threats by ensuring complete network segregation, with the fabrics operating independently within their assigned security contexts and never crossing enclave boundaries. Security boundaries implement defense mechanisms including traffic validation, protocol enforcement, credential verification, and communication pattern monitoring, creating security zones with clearly defined trust relationships and controlled information exchange mechanisms.

In an embodiment, workload execution enclave 120 functions as a dedicated customer environment for executing computational workloads in a cloud infrastructure. Workload execution enclave 120 corresponds to a customer-specific zone within a larger datacenter environment operated by a cloud service provider. Workload execution enclave 120 implements security boundaries that permit outbound telemetry transmission while blocking certain inbound control signals from external systems to provide security and isolation to the workload execution enclave 120. In one example, workload execution enclave 120 houses high-performance computing equipment such as GPU servers for machine learning workloads or general-purpose computing. Workload execution enclave 120 implements one or more security policies that specifically allow egress traffic and prohibit ingress traffic, establishing a unidirectional communication model. Workload execution enclave 120 operates under control of a cloud customer while cloud management enclave 140 operates under control of a cloud services provider. In one embodiment, the cloud services provider is a “colo provider” (short for colocation provider) for the workload execution enclave 120 and the cloud customer is a customer of the colo provider. A colo provider is a company that offers data center space and facilities for businesses to house their own servers and networking equipment, providing the physical infrastructure, power, cooling, and security, while the business retains ownership and control of their hardware.

In an embodiment, network fabric 122A constitutes a secure communication infrastructure within workload execution enclave 120 for connecting computing devices and sensor systems. Network fabric 122A typically includes physical network switches, routers, and cabling arranged in redundant topologies for high availability. In an example, network fabric 122A implements security policies through access control lists and traffic filtering at network boundaries. Network fabric 122A terminates at enclave perimeters to maintain strict isolation between security domains. In one example, network fabric 122A operates independently with no network fabric crossing into multiple enclaves in the multi-enclave architecture.

In an embodiment, computing devices, such as computing device 124A, serves as the primary computational platform within workload execution enclave 120 for executing customer workloads. Computing device 124A encompasses server hardware including processors, memory, storage, and networking interfaces for specific workload types. In an embodiment, the computing device 124A is a GPU and the workload execution enclave 120 includes GPU racks and GPU servers. In one example, computing device 124A generates substantial heat during operation, necessitating advanced cooling solutions such as liquid cooling for high-density deployments. Computing device 124A includes built-in environmental sensors monitoring operational parameters such as temperature, power consumption, and coolant status.

In an embodiment, workload 126 denotes the computational tasks executed on computing device 124A within workload execution enclave 120. Workload 126 typically includes customer applications such as data analytics processes, machine learning training jobs, or scientific simulations requiring significant computational resources. In an example, workload 126 exhibits variable resource utilization patterns creating fluctuating power consumption and thermal loads. Workload 126 often includes GPU-intensive operations characterized by rapid transitions from idle to maximum power states. Workload 126 performance parameters serve as leading indicators for infrastructure management decisions. In one example, workload 126 generates rapid power utilization changes from idle to full capacity, presenting cooling system challenges due to these rapid power consumption changes.

In an embodiment, sensor 128 collects environmental and operational metrics within workload execution enclave 120. Sensor 128 is associated with a device, such as computing device computing device 124A or a power device. In one example, the sensors are Integrated Lights Out Management (ILOM) sensors that monitor power usage, temperature levels, and leak detection. Sensor 128 includes temperature probes, power monitors, liquid flow meters, and/or moisture detection systems integrated with computing infrastructure. Sensor 128 provides critical early warning signals for abnormal conditions such as cooling failures, power anomalies, or liquid leaks. Sensor 128 operates independently from primary computing resources to maintain monitoring capabilities during system failures. Sensor 128 enables proactive facilities management through continuous environmental awareness. In one example, sensors, such as sensor 128, accesses temperature readings per server blade, enabling detection of cooling system blockages or flow issues and providing granular monitoring capabilities across equipment.

In an embodiment, baseboard management controller 130 operates as a specialized service processor providing out-of-band management capabilities for computing devices in workload execution enclave 120. Baseboard management controller 130 typically integrates with server motherboards as a dedicated microcontroller with independent power and network connectivity separate from main system resources. Baseboard management controller 130 collects telemetry from integrated sensors throughout computing devices even when primary systems remain powered down. In one example, baseboard management controller 130 implements industry-standard interfaces such as IPMI (Intelligent Platform Management Interface) for consistent monitoring across heterogeneous hardware. Baseboard management controller 130 serves as a secure gateway for operational data exiting workload execution enclave 120. In one example, baseboard management controller 130 includes sensor 128 as integrated lights out management (ILOM) sensors that monitor power usage, temperature levels, and leak detection status across customer equipment. Baseboard management controller 130 benefits from a specific connection established in the workload execution enclave for external communication, while no connection exists in the workload execution enclave for external communication with sensor 128 or computing device 124A, enhancing security through restricted communication paths.

In an embodiment, telemetry data 132 comprises structured information streams including operational metrics collected from computing environments within workload execution enclave 120. Telemetry data 132 includes measurements of power consumption, temperature values, coolant flow rates, and/or binary status indicators from leak detection systems. In one embodiment, telemetry data 132 includes time-series measurements. Telemetry data 132 follows standardized formats enabling automated processing by monitoring applications.

In one embodiment, telemetry data 132 is sent between the workload execution enclave 120 and cloud management enclave 140 using a dedicated communication channel. A dedicated communication channel is a direct private pathway between networks that bypasses the public internet. These channels are characterized by their consistent bandwidth allocation, significantly reduced and predictable latency, and enhanced security through physical or logical isolation. Whether implemented through dedicated peering connections at shared facilities and/or through direct physical fiber links, these channels establish a reliable, high-performance conduit for data transmission that supports mission-critical applications. In one embodiment, the connection leverages standardized routing protocols like border gateway protocol (BGP) to manage traffic flow while maintaining strict separation from public network traffic, effectively creating a private extension of an organization's network into cloud environments or between data centers with guaranteed service levels and performance characteristics. In an example, the dedicated connection is a peering connection that establishes a direct, private network link between a company's on-premises infrastructure and a cloud provider's network edge. This connection bypasses the public internet entirely, creating a dedicated pathway with consistent, guaranteed bandwidth and substantially lower latency than conventional internet-based connections. The resulting connection delivers predictable performance characteristics with service level agreements covering availability and throughput for applications that require reliable network performance, enhanced security, and consistent data transfer rates.

In an embodiment, cloud management enclave 140 enforces security boundaries through credential management, network segmentation, and application-level access controls. Cloud management enclave 140 provides an architectural barrier preventing direct customer access to critical infrastructure control systems. Cloud management enclave 140 operates under cloud provider authority rather than customer direction for infrastructure protection.

In an embodiment, network fabric 122B provides secure network infrastructure within cloud management enclave 140 connecting monitoring applications with telemetry sources and facilities systems. Network fabric 122B implements security policies enforcing directional data flows between security domains. Network fabric 122B typically includes redundant physical and logical connectivity paths for high availability of management functions. Network fabric 122B maintains separation from customer network segments through distinct physical or virtual network domains. Network fabric 122B supports secure transmission protocols for sensitive operational data crossing security boundaries. Network fabric 122B connects to network fabric 122A through a direct connection made between the workload execution enclave 120 and the cloud management enclave 140, while another direct connection is made between the cloud management enclave 140 and the facilities management enclave 160.

In an embodiment, computing device 124B serves as the execution platform for management applications within cloud management enclave 140. Computing device 124B executes telemetry processing algorithms identifying significant operational events requiring facilities response. Computing device 124B implements security hardening measures protecting management functions from unauthorized access. Computing device 124B operates under cloud provider control rather than customer direction for consistent security governance. In one example, computing device 124B maintains stateless operation while sharing state through a centralized database, with timestamp-based arbitration ensuring only the latest telemetry updates propagate to control systems.

In an embodiment, cloud management services 142 constitute specialized software applications executing within cloud management enclave 140 for infrastructure monitoring and management. Cloud management services 142 includes bridge 143 that implements telemetry processing pipelines transforming raw sensor data into actionable facilities intelligence. Cloud management services 142 detect anomalous conditions such as coolant leaks or workload spikes requiring immediate facilities intervention. Cloud management services 142 enrich telemetry with contextual information such as physical location data for targeted response actions. Cloud management services 142 maintain operational state databases tracking infrastructure conditions across multiple customer environments. Bridge 143 filters and packages telemetric data before transmission to controllers, maintaining security controls across enclave boundaries while enabling analysis and logging functions. Cloud management services 142 possess one or more credentials for transmitting data to facilities control system 162 in facilities management enclave 160, while components in workload execution enclave 120 lack any credentials for transmitting data to facilities control system 162, enforcing the security boundary between enclaves. Bridge 143 ensures that the appropriate security controls are in place for the traffic going across enclaves.

In an embodiment, telemetry filtering 144 functions as a specialized data processing component within cloud management services 142 reducing telemetry volume through intelligent state change detection. Telemetry filtering 144 implements filtering logic to reduce control system data volume by identifying state changes requiring control system notification while suppressing redundant updates. Telemetry filtering 144 implements methods distinguishing significant operational changes from normal background variations in sensor readings. Telemetry filtering 144 suppresses redundant updates when values remain within expected operational parameters. Telemetry filtering 144 passes through critical events requiring immediate attention regardless of update frequency rules. Telemetry filtering 144 transforms high-volume raw sensor streams into manageable information flows for facilities control systems.

In an embodiment, coolant leak detection 146 serves as a specialized monitoring function within cloud management services 142 analyzing sensor readings for indications of liquid coolant escaping containment. Coolant leak detection 146 enables the rapid response to equipment abnormalities through targeted control actions, where upon detecting a leak from server-level sensors, the system immediately notifies controllers to isolate affected equipment through power and cooling shutdowns. Coolant leak detection 146 processes inputs from sensors to identify presence of liquid leaks. Coolant leak detection 146 triggers immediate emergency notifications upon leak confirmation for rapid facilities response.

In an embodiment, workload detection 148 operates as an analytical component within cloud management services 142 identifying changes in processing activity through power consumption patterns. Workload detection 148 anticipates workload surges through power consumption monitoring at a granular level, where when an ILOM or a rack Power Distribution Units detect increased power draw from specific GPUs, the monitoring module transmits these early warning signals to controllers. Workload detection 148 determines when an increase in power consumption at a GPU satisfies a specific trigger criterion, then instructs facilities control system 162 to increase cooling for the GPU when the trigger criterion becomes satisfied. Workload detection 148 recognizes signature power utilization curves associated with specific workload types such as GPU training jobs or large-scale data analytics. Workload detection 148 enables predictive cooling adjustments, including increasing cooling by chillers 166, based on expected thermal profiles of identified workload types. Workload detection 148 correlates current power signatures with historical patterns to anticipate computational intensity and duration. Workload detection 148 thus enables proactive cooling adjustments rather than just a reactive temperature response.

In an embodiment, processed telemetry data 150 constitutes filtered, enriched information streams that are processed from telemetry data 132 by cloud management enclave 140. Processed telemetry data 150 are sent from cloud management enclave 140 to facilities management enclave 160. Processed telemetry data 150 includes only significant state changes requiring facilities action rather than raw sensor readings. Processed telemetry data 150 provides physical location context enabling targeted infrastructure responses to specific equipment areas. Processed telemetry data 150 follows standardized formats compatible with industrial control systems in facilities management environments. Processed telemetry data 150 is transmitted through a dedicated communication channel preventing unauthorized command injection into facilities systems. In one example, processed telemetry data 150 includes physical location data to target control responses. In one embodiment, processed telemetry data 150 includes emergency response instructions such as processed leak alerts.

In an embodiment, facilities management enclave 160 establishes a dedicated security zone including control systems for physical infrastructure supporting computing operations. Facilities management enclave 160 implements specialized industrial control networks separated from information technology environments through physical and logical boundaries. Facilities management enclave 160 includes systems managing cooling infrastructure, power distribution, and environmental controls essential for datacenter operations. Facilities management enclave 160 receives processed telemetry from cloud management enclave 140 through restricted communication channels. Facilities management enclave 160 operates under facilities engineering authority rather than information technology or customer direction. Facilities management enclave 160 corresponds to the network enclave operating control systems, with no peering connection established between the workload execution enclave and the facilities management enclave.

In an embodiment, network fabric 122C provides specialized connectivity infrastructure within facilities management enclave 160 connecting control systems with physical infrastructure components. Network fabric 122C typically implements industrial control network protocols for deterministic performance. Network fabric 122C remains physically separated from information technology networks for security and reliability purposes.

In an embodiment, computing device 124C functions as the execution platform for facilities control software managing physical infrastructure components. Computing device 124C typically utilizes industrial-grade hardware designed for long-term reliability in critical infrastructure environments. Computing device 124C often incorporates specialized input/output interfaces for connecting with industrial control equipment such as programmable logic controllers. Computing device 124C implements multiple redundancy measures ensuring continuous operation during component failures. In one example, computing device 124C corresponds to the Programmable Logic Controllers (PLCs) that isolate affected equipment by controlling power and cooling systems at the rack level upon receiving notifications of abnormalities.

In an embodiment, facilities control system 162 serves as the centralized management platform coordinating physical infrastructure operations throughout the datacenter. Facilities control system 162 processes incoming telemetry from cloud management enclave 140 to determine appropriate control responses for cooling and power systems. Facilities control system 162 implements programmed response sequences for emergency conditions such as coolant leaks or power anomalies. Facilities control system 162 balances cooling capacity with processing demands for efficient operations while maintaining equipment safety margins.

In an embodiment, coolant system 164 encompasses the physical infrastructure circulating liquid cooling media through devices, such as computing devices and power devices, to remove heat. Coolant system 164 typically includes pumps, distribution manifolds, flexible tubing connections, heat exchangers, and control valves managing coolant flow throughout the datacenter. Coolant system 164 connects to devices through quick-disconnect couplings featuring leak prevention mechanisms for maintenance operations. Coolant system 164 incorporates isolation valves enabling selective shutdown of coolant paths during leak events or maintenance. Coolant system 164 enables high-density computing deployments through superior thermal transfer properties of liquid cooling compared to traditional air cooling. Coolant system 164 allows cooling systems to prepare for increased thermal loads based on power utilization patterns, as the bridge enables preemptive cooling system adjustment based on power draw indicators before thermal effects manifest.

In an embodiment, chillers 166 function as specialized heat extraction equipment removing thermal energy from liquid coolant returning from devices. Chillers 166 typically utilize refrigeration cycles or cooling towers to transfer heat from internal closed-loop coolant systems to external environments. Chillers 166 incorporate variable capacity controls adjusting cooling output based on current and anticipated thermal loads from computing equipment. As discussed above, chillers 166 respond to workload spike notifications from management systems with preemptive capacity increases before temperature rises occur. Chillers 166 maintain coolant supply temperatures within desired operational ranges for computing equipment performance and reliability. Chillers 166 are directed by the system to increase cooling for increased computational workloads, where the advance notice allows chillers and cooling infrastructure to prepare ahead of thermal spikes. Chillers 166 pump liquid coolant to cold plates a GPU, with cooling increased specifically for GPU cold plates when power consumption triggers indicate heightened thermal loads are imminent.

In an embodiment, power system 168 delivers electrical energy to computing equipment throughout the datacenter through managed distribution infrastructure. Power system 168 typically includes uninterruptible power supplies, power distribution units, automatic transfer switches, and backup generators ensuring continuous operation during utility power disruptions. Power system 168 incorporates extensive monitoring capabilities tracking consumption patterns at various granularity levels from individual servers to entire racks. Power system 168 implements emergency shutdown capabilities during critical events such as coolant leaks threatening electrical safety. Power system 168 coordinates with cooling systems ensuring balanced infrastructure operations supporting computing workloads. Power system 168 includes rack power distribution units and/or PowerShelves that are polled by a monitoring module for additional telemetric data, while a handler manages data publication to the control systems.

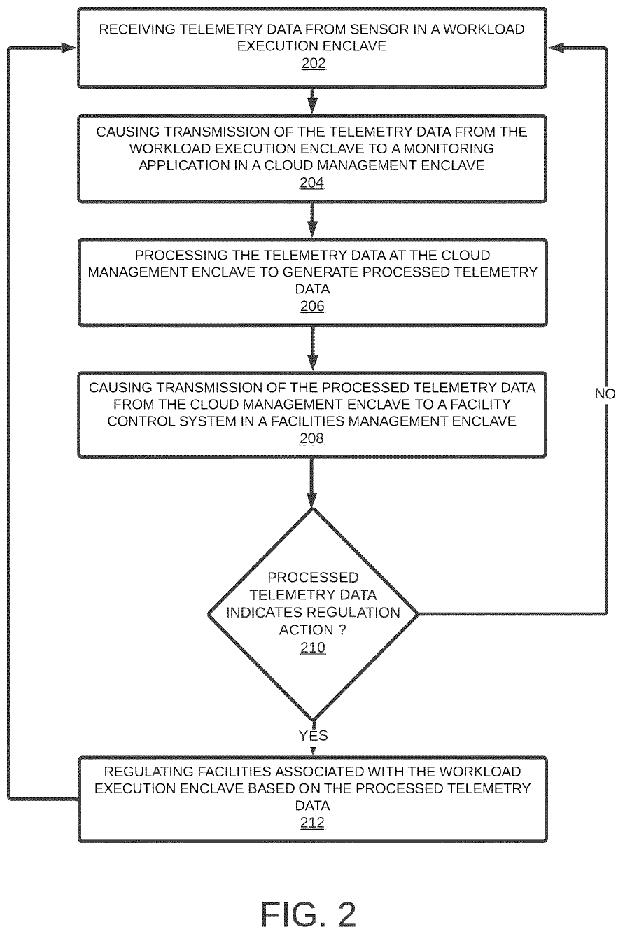

In one or more embodiments, workload 126, telemetry data 132, cloud management services 142, telemetry filtering 144, coolant leak detection 146, workload detection 148, processed telemetry data 150 refer to hardware and/or software configured to perform operations described herein for facilities management. Examples of operations for facilities management are described below with reference to FIGS. 2, 3 and 4.

In accordance with an embodiment, workload 126, telemetry data 132, cloud management services 142, telemetry filtering 144, coolant leak detection 146, workload detection 148, and processed telemetry data 150 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. FACILITIES MANAGEMENT METHOD

FIG. 2 illustrates an example set of operations for processing telemetry data using workload execution enclave and a cloud management enclave in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

A datacenter network implements multiple network enclaves, with groups of devices isolated from other enclaves. The architecture establishes three distinct enclaves: a workload execution enclave including computing devices, such as GPU servers, executing sensitive customer workloads along with associated sensors, a cloud management enclave executing cloud management services with monitoring applications, such as a bridge, and a facilities management enclave operating facility control systems. Traffic between enclaves remains controlled through various mechanisms including physical cabling, traffic rules, and security policies. The workload execution enclave allows egress traffic while prohibiting or restricting ingress traffic to maintain isolation. This unidirectional traffic flow ensures that external systems cannot directly access or compromise customer workloads while still enabling necessary monitoring and management functions. In one example, the workload execution enclave is a customer enclave managed by cloud provider while configured to execute workloads for customer associated with customer enclave. The workload execution enclave and cloud management enclave operating under control of different entities-workload execution enclave operating under customer control while cloud management enclave operates under cloud service provider control. This separation of control establishes clear boundaries of responsibility and authority, allowing customers to maintain sovereignty over their workloads while enabling the provider to ensure facility-wide stability and efficiency.

In an embodiment, the system receives telemetry data from sensors in a workload execution enclave (Operation 202). The sensors monitor environmental conditions including temperature values, power consumption metrics, coolant flow rates, and moisture detection states throughout computing infrastructure. In one example, telemetry data flows from baseboard management controllers having independent power supplies separate from primary computing resources. Baseboard management controllers serve as authorized communication points for telemetry data egress, while direct external access to sensors or devices, such as computing devices, remains prohibited by security policy.

In an embodiment, the system transmits telemetry data from workload execution enclave to a monitoring application in cloud management enclave (Operation 204). The transmission occurs over channels using standardized protocols that maintain data integrity while preventing unauthorized access or manipulation during transit. In one example, a direct communication channel, such as a peering connection, links the workload execution enclave with cloud management enclave, another direct communication channel links the cloud management enclave with facilities management enclave, while no direct communication channel exists between workload execution enclave and facilities management enclave. Communication channels bypass public internet infrastructure while maintaining consistent bandwidth allocation and reduced latency characteristics. In one example, peering connections establish direct links between workload execution enclave networks and cloud management enclave network edges through a border gateway protocol implementation.

In an embodiment, the system processes telemetry data at cloud management enclave to generate processed telemetry data (Operation 206). Processing includes filtering operations reducing telemetry volume through state change detection algorithms. Bridge components implement filtering logic distinguishing significant operational changes from normal background variations in sensor readings. The monitoring application filters telemetry data by identifying state changes requiring control system notification while suppressing redundant updates. In one example, the bridge enriches telemetry data with location data that maps sensors or devices to physical locations within datacenter or to relevant facilities for targeting responses. The bridge mediates communications between customer equipment telemetry and provider control systems across separate network enclaves while ensuring appropriate security controls for cross-enclave traffic. In one example, redundant updates remain suppressed when values stay within expected operational parameters.

In an embodiment, the system transmits processed telemetry data from cloud management enclave to facility control system in facilities management enclave (Operation 208). The transmission includes metadata identifying the source, priority, and required action type, enabling the receiving systems to properly categorize and route information to appropriate subsystems for handling. Cloud management enclave maintains separation from the facilities management enclave through credential management and network segmentation techniques. Components within cloud management enclave possess necessary credentials to transmit data to facility control systems. In one example, there is no direct network connectivity existing between customer execution enclave and facilities management enclave. Processed telemetry is transmitted through authenticated communication channels preventing unauthorized command injection into facilities systems. Processed telemetry data follows standardized formats compatible with industrial control systems present in facilities management environments.

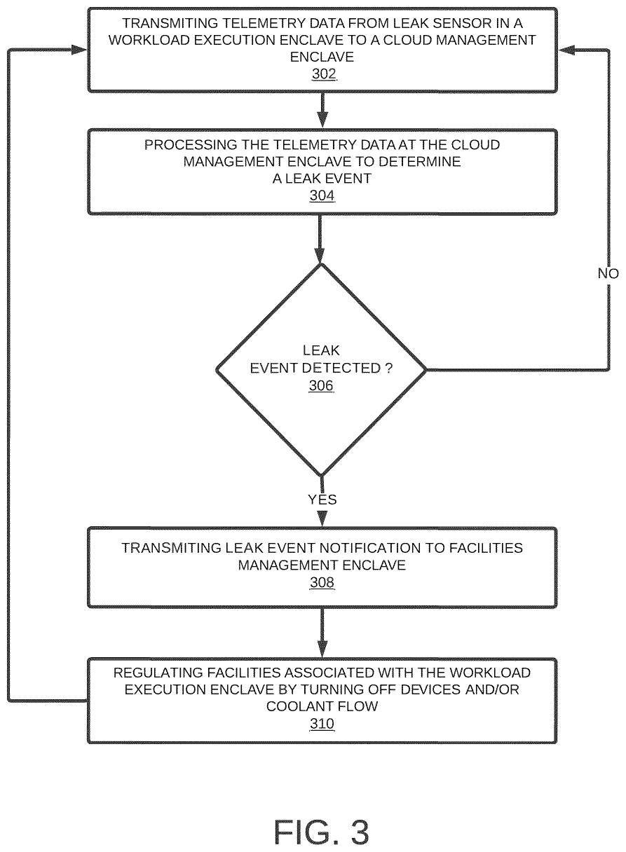

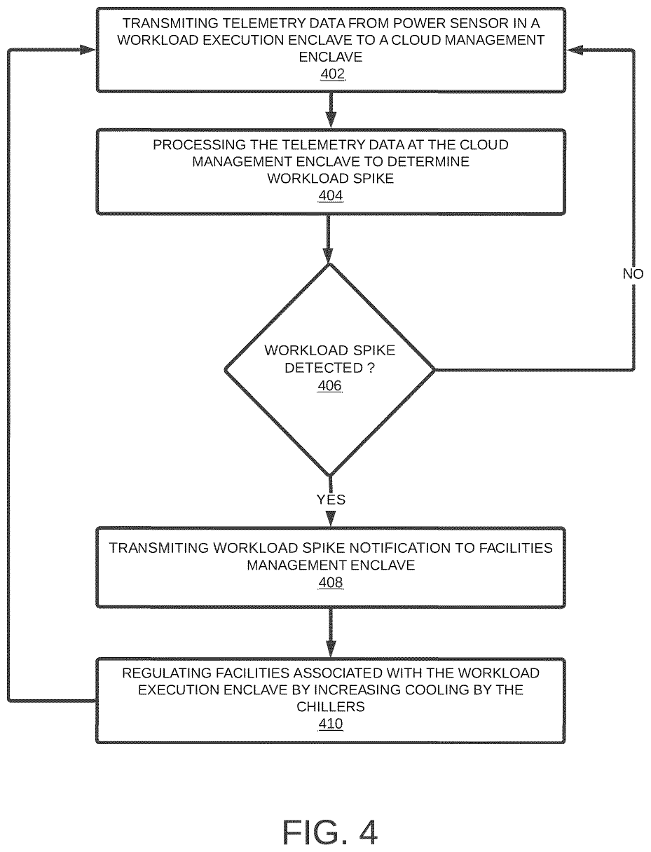

In an embodiment, the system evaluates processed telemetry data for regulation action requirements (Operation 210). Evaluation determines when measured values exceed predefined thresholds warranting facility adjustments. When facility adjustments are warranted, the system determines selects regulation actions for performing the facility adjustments. Decision logic applies different thresholds depending on telemetry types ranging from temperature values to coolant moisture detection states. Critical events pass through regardless of update frequency rules while normal state changes undergo additional filtering stages. Evaluation incorporates historical context comparing current values against established baseline patterns. Examples for coolant leak detection and workload spikes are discussed below with respect to FIGS. 3 and 4 respectively. If NO in operation 210, then the system returns to operation 202. If YES in operation 210, then the system proceeds to operation 212.

In an embodiment, the system regulates facilities associated with workload execution enclave based on processed telemetry data (Operation 212). Regulation includes adjusting cooling capacity through chiller control instructions responding to workload spike detections and sequences for emergency conditions such as coolant leaks or power anomalies. Regulation actions balance cooling capacity with processing demands for efficient operations while maintaining equipment safety margins. Facilities control systems initiate coordinated responses across cooling distribution networks and power delivery infrastructure.

### 4. DETECTING AND RESPONDING TO COOLANT LEAKS

FIG. 3 illustrates an example set of operations for detecting and responding to coolant leak events, including transmitting notifications between enclaves and implementing appropriate facility regulation measures in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, the system transmits telemetry data from leak sensors in the workload execution enclave to the cloud management enclave (Operation 302). The leak sensors are associated with devices such as computing devices or power devices. Transmission occurs at both regular intervals for routine monitoring and via immediate push notifications when sensor values exceed predefined alert thresholds, ensuring timely response to potential leak situations. Telemetry data comprises coolant leak detection telemetry data collected by leak sensors associated with devices, such as computing devices or power devices, in workload execution enclave. Leak sensors monitor for the presence of liquid. For liquid cooling implementations, cold plates mount directly on GPU chips with chillers pumping coolant through these cold plates to regulate GPU temperatures, creating a risk of coolant leaks requiring immediate detection and response. Moisture detection systems trigger immediate alerts upon detecting liquid presence outside expected containment areas. In one example, leak detection operates through integrated sensors across racks including server-level detection capabilities providing earlier warning than traditional systems. Detection sensitivity enables identification of small leaks before substantial equipment damage occurs.

In an embodiment, the system processes telemetry data at the cloud management enclave to determine existence of leak events (Operation 304). Processing correlates multiple sensor readings across physical areas to confirm leak presence while minimizing false positives. The bridge aggregates data from multiple sensors, filters false positives, converts raw sensor readings into actionable commands, formats data for facility control system interpretation, adds necessary metadata, and validates readings against established thresholds to address substantial data processing requirements before transmission. Detection logic employs signature-based recognition comparing current sensor patterns against known leak event profiles.

In an embodiment, the system evaluates detection results to confirm presence of leak events (Operation 306). Evaluation incorporates physical proximity analysis considering probable leak spread patterns across equipment configurations. Confirmation includes escalating certainty levels determining appropriate response urgency from minimal isolation to complete shutdown sequences. If NO in operation 306, then the system returns to operation 302. If YES in operation 210, then the system proceeds to operation 308.

In an embodiment, the system transmits leak event notifications to facilities management enclave upon leak confirmation (Operation 308). Notifications are distributed through multiple channels including facility control system integration, operations team alerts, automated incident management system tickets, and monitoring dashboards to ensure appropriate visibility by responsible parties. Notifications include precise location information enabling targeted response actions addressing specific equipment areas. In one example, the location data includes rack identifiers, unit position, server specifications, and affected component details that enable response teams to navigate directly to the precise leak location without time-consuming search procedures. Message formatting follows industrial control protocols ensuring compatibility with supervisory control systems. Notifications carry severity classifications determining response prioritization across multiple potential simultaneous events.

In an embodiment, the system regulates facilities associated with workload execution enclave by turning off devices or stopping coolant flow (Operation 310). Regulation implements emergency shutdown procedures isolating affected equipment through immediate power disconnection preventing electrical hazards from moisture exposure. Coolant system valve controls activate to segment distribution networks to contain leaks. Response sequences follow predefined emergency protocols with escalating containment procedures based on leak severity classifications. Programmable logic controllers execute coordinated shutdown sequences across power distribution units and coolant distribution units.

### 5. MONITORING AND RESPONDING TO WORKLOAD SPIKES

FIG. 4 illustrates an example set of operations for monitoring and responding to workload spikes in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, the system transmits telemetry data from power sensors in workload execution enclave to the cloud management enclave (Operation 402). Power sensors monitor consumption metrics at various granularity levels from individual servers to entire racks. Transmission includes measurement data from baseboard management controllers providing near real-time power utilization visibility. Power telemetry data collection occurs through sensors located at power distribution devices, GPUs, or other locations within the workload execution enclave, with incoming data streams providing power utilization metrics and processor activity levels. Power distribution units generate telemetry indicating current draw patterns across the devices. Sensing capabilities detect rapid transitions between idle states and full computational load conditions reflecting changing workload demands.

In an embodiment, the system processes telemetry data at cloud management enclave to determine workload spikes (Operation 404). Processing combines real-time analysis with historical pattern matching to distinguish between normal variations and genuine workload spikes requiring facility adjustments. The system identifies signature power utilization curves associated with specific workload types such as GPU training jobs. The bridge enriches telemetry data with physical location context by mapping device identifiers to precise datacenter positions using comprehensive facility data models, enabling control systems to target specific cooling infrastructure including exact cooling distribution units and valves serving particular racks. In an example, the system correlates current power signatures with historical patterns anticipating computational intensity duration. In an example, the telemetry data is power telemetry data collected by sensors associated with graphics processing units. The system analyses power consumption to determine trigger criteria for cooling adjustments rather than relying on conventional temperature data. The system differentiates between gradual power increases versus rapid state transitions requiring immediate cooling adjustments. In an example, the system transforms raw power measurements into expected thermal loading predictions enabling proactive infrastructure responses.

In an embodiment, the system evaluates detection results confirming presence of workload spikes (Operation 406). The system applies threshold-based rules determining when power consumption increases satisfy specific trigger criteria. The system analyzes historical power consumption and temperature data to establish and refine trigger criteria for cooling adjustments, with these criteria used to predict temperature spikes based on power consumption patterns, enabling preemptive cooling system responses. In one example, determining that an increase in power consumption at graphics processing units satisfies trigger criterion results in instructions to facility control system to increase cooling for affected graphics processing units when trigger criterion becomes satisfied. If NO in operation 406, then the system returns to operation 402. If YES in operation 406, then the system proceeds to operation 408.

In an embodiment, the system transmits workload spike notifications to facilities management enclave (Operation 408). Notifications include physical location context enabling targeted cooling responses addressing specific equipment zones. In one example, the messages carry thermal load predictions derived from power consumption patterns observed during initial spike detection allowing cooling infrastructure preparation ahead of temperature increases.

In an embodiment, the system regulates facilities associated with workload execution enclave by increasing a cooling function by the chiller (Operation 410). Regulation increases coolant circulation rates through affected zones including servers experiencing workload spikes. The facility control system proactively increases cooling by adjusting liquid coolant flow rates through GPU cold plates and/or increasing chiller cooling capacity before temperature increases are detected, addressing challenges from GPU operations that rapidly transition from idle to full utilization states. In some systems, chillers require a few seconds to ramp up and thus these chillers are activated as a result of a workload spike before a temperature spike occurs. Increasing cooling for graphics processing units comprises increasing cooling of chillers that pump liquid coolant to cold plates of affected graphics processing units through one or more facilities including liquid cooling system. In one example, controllers coordinate pump speeds, valve positions, and heat exchanger capacities across distribution networks serving specific equipment areas experiencing increased computational demands.

### 6. EXEMPLARY OPERATIONAL FLOWS FOR MULTI-ENCLAVE CLOUD INFRASTRUCTURE FACILITIES MANAGEMENT

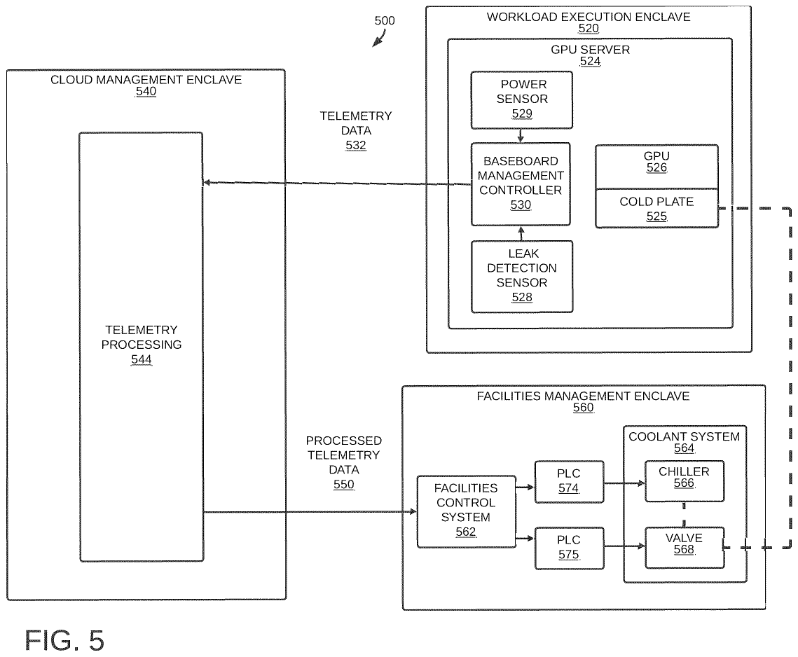

FIG. 5 illustrates an example operational flows for multi-enclave cloud infrastructure facilities management in accordance with one or more embodiments. System 500 includes workload execution enclave 520, GPU server 524, GPU 526, cold plate 525, leak detection sensor 528, power sensor 529, baseboard management controller 530, telemetry data 532, cloud management enclave 540, telemetry processing 544, processed telemetry data 550, facilities management enclave 560, facilities control system 562, coolant system 564, chiller 566, valve 568, PLC 574, and PLC 575.

### A. OPERATIONAL FLOW FOR COOLANT LEAK DETECTION

In an embodiment, leak detection sensor 528 within GPU server 524 detects liquid coolant leaks. Leak detection sensor 528 monitors for presence of moisture at critical junction points including cold plate 525 connections, coolant distribution manifolds, and server chassis low points. Leak detection sensor 528 generates alert signals upon detecting liquid presence, transmitting these signals to baseboard management controller 530.

In an embodiment, baseboard management controller 530 receives alert signals from leak detection sensor 528 indicating potential coolant leaks. Baseboard management controller 530 packages these alerts into telemetry data 532. Baseboard management controller 530 adds server identity information and timestamp data to telemetry data 532 before secure transmission to telemetry processing 544 in cloud management enclave 540.

In an embodiment, telemetry processing 544 processes incoming leak detection alerts in telemetry data 532 with a high priority status. Telemetry processing 544 performs initial validation of leak alerts through correlation with other sensor readings from affected equipment. Telemetry processing 544 enriches leak detection data with critical contextual information including physical location data mapping affected equipment to datacenter floor plans. Telemetry processing 544 generates emergency response instructions including equipment shutdown sequences and coolant isolation procedures. Telemetry processing 544 packages these instructions into processed telemetry data 550 for transmission to facilities management enclave 560.

In an embodiment, facilities control system 562 receives leak event notifications through processed telemetry data 550 and initiates emergency response protocols. Facilities control system 562 determines affected cooling circuits requiring isolation based on location data provided in processed telemetry data 550. Facilities control system 562 transmits shutdown commands to PLCs such as PLC 574 and PLC 575.

In an embodiment, PLC 575 executes emergency isolation procedures upon receiving leak event commands from facilities control system 562. PLC 575 commands valve 568 to closed position, halting coolant flow to affected server areas. PLC 575 maintains valve 568 in closed position until receiving reset commands following incident remediation.

In an embodiment, PLC 574 coordinates with chiller 566 to adjust pressure within coolant distribution systems during leak events. PLC 574 reduces pressure in affected coolant circuits to minimize liquid escape while maintaining cooling capability in unaffected zones. PLC 574 implements gradual pressure reduction sequences preventing shock to coolant system 564 components.

### B. OPERATIONAL FLOW FOR WORKLOAD SPIKE MANAGEMENT

In an embodiment, power sensor 529 monitors electricity consumption at GPU 526 in real-time. Power sensor 529 detects rapid power draw increases indicating GPU 526 transitioning from idle to full computational load during workload execution. Power sensor 529 samples power consumption metrics at short intervals. In one example, power sensor 529 distinguishes between gradual power increases versus rapid state transitions requiring immediate cooling adjustments.

In an embodiment, baseboard management controller 530 collects power utilization data from power sensor 529 monitoring the operational state of GPU 526. Baseboard management controller 530 packages power metrics into telemetry data 532 for transmission to telemetry processing 544 in cloud management enclave 540.

In an embodiment, telemetry processing 544 analyzes power consumption patterns within telemetry data 532 to identify signature curves indicating specific workload types. Telemetry processing 544 performs pattern matching between current power consumption data and historical workload profiles. Telemetry processing 544 calculates anticipated thermal outputs based on identified power consumption patterns at GPU 526. Telemetry processing 544 generates predictive cooling instructions targeting specific equipment locations before temperature increases occur. Telemetry processing 544 packages predictive cooling instructions into processed telemetry data 550 for transmission to facilities management enclave 560.

In an embodiment, facilities control system 562 receives workload spike notifications through processed telemetry data 550 and initiates preemptive cooling adjustments. Facilities control system 562 determines affected cooling circuits requiring increased capacity based on location data provided in processed telemetry data 550. Facilities control system 562 transmits capacity increase commands to PLC 574 controlling chiller 566 and flow rate adjustment commands to PLC 575 controlling valve 568.

In an embodiment, PLC 574 executes capacity increase procedures upon receiving workload spike notifications from facilities control system 562. PLC 574 commands chiller 566 to increase cooling output before temperature rises occur at GPU 526. Chiller 566 typically takes a second or so to become active. PLC 574 implements ramping sequences gradually increasing cooling capacity preventing thermal shock to system components.

In an embodiment, PLC 575 adjusts valve 568 positions to increase coolant flow rates through cold plate 525 attached to GPU 526 experiencing workload spikes. PLC 575 cools targeted GPU 526 while maintaining adequate flow through remaining server cooling circuits. PLC 575 adjusts valve 568 positions based on subsequent telemetry updates throughout workload execution.

In an embodiment, cold plate 525 receives increased coolant flow enabling efficient heat extraction from GPU 526 during peak computational periods. Cold plate 525 maintains temperature stability at GPU 526 despite rapid power consumption increases through increased thermal conduction properties. Cold plate 525 prevents thermal throttling conditions at GPU 526 resulting in consistent computational performance throughout workload execution.

### 7. PRACTICAL APPLICATIONS, ADVANTAGES & IMPROVEMENTS

One or more embodiments provide significant technical improvements in facilities management. The system architecture establishes robust security boundaries that protect sensitive processing operations from unauthorized access or manipulation. Separation between sensor telemetry collection and cloud management functions prevents direct exposure of workload environments to external networks. Telemetry data is transmitted through controlled communication channels with authentication requirements that ensure that only authorized monitoring applications receive sensor information. The enclave structure prevents lateral movement attempts by potential attackers, as compromise of facilities management systems would not automatically grant access to workload execution environments. The architecture implements compartmentalization of functions across dedicated enclaves, reducing attack surfaces while enabling comprehensive monitoring capabilities.

### 8. EXAMPLES OF CLOUD INFRASTRUCTURE

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>. [REGION][. FUTURE USE]. <UNIQUE ID>
where,
cid1: The literal string indicating the version of the CID; resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name; region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

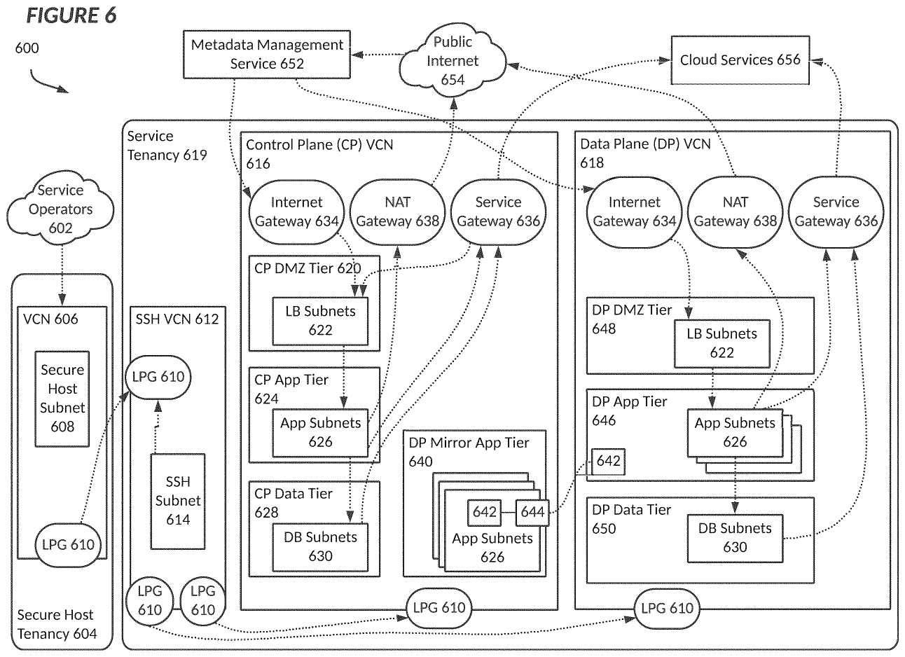

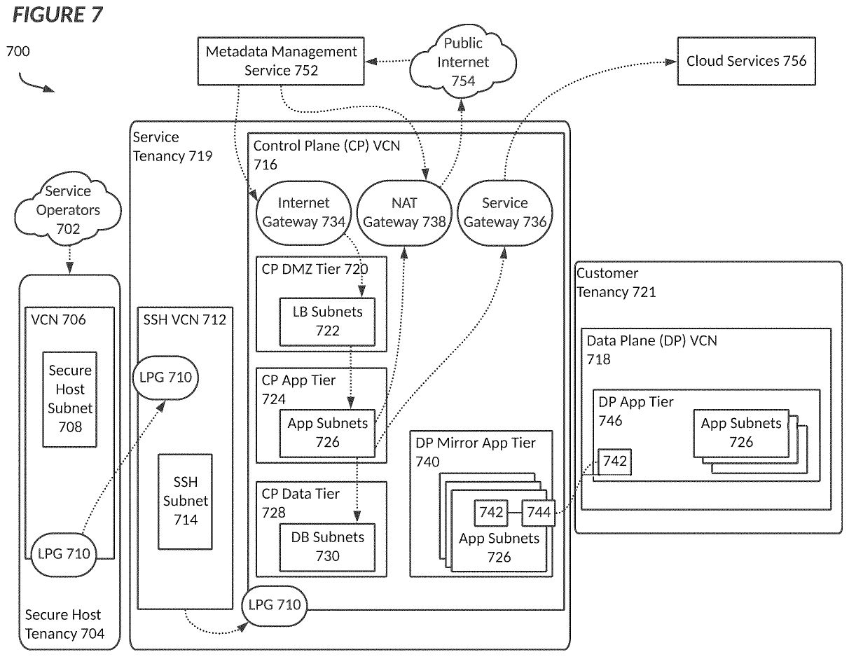

FIG. 6 is a block diagram illustrating an example pattern of an IaaS architecture 600 according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and be Internet, e-mail, short message service (SMS), Blackberry®, or other communication protocol enabled. Alternatively, the client computing devices can be general purpose personal computers, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 implemented in the SSH VCN 612. The SSH VCN 612 can include an SSH subnet 614, and the SSH VCN 612 can be communicatively coupled to a control plane VCN 616 via the LPG 610 implemented in the control plane VCN 616. Also, the SSH VCN 612 can be communicatively coupled to a data plane VCN 618 via an LPG 610. The control plane VCN 616 and the data plane VCN 618 can be implemented in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 in the control plane DMZ tier 620 can be communicatively coupled to the app subnet(s) 626 in the control plane app tier 624 and an Internet gateway 634 that can be implemented in the control plane VCN 616. The app subnet(s) 626 can be communicatively coupled to the DB subnet(s) 630 implemented in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 implemented in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be implemented in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively couple to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way; the service gateway 636 can make API calls to cloud services 656, and cloud services 656 can send requested data to the service gateway 636. However, cloud services 656 may not initiate API calls to the service gateway 636.

In some examples, the secure host tenancy 604 can be directly connected to the service tenancy 619. The service tenancy 619 may otherwise be isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision resources. Resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be implemented in the data plane mirror app tier 640 and the data plane app tier 646.

In some examples, users or customers, of the system, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 implemented in the control plane DMZ tier 620. The LB subnet(s) 622 may determine that the request is valid, and in response, the LB subnet(s) 622 can transmit the request to app subnet(s) 626 implemented in the control plane app tier 624. If the request is validated and requires a call to public Internet 654, the call to public Internet 654 may be transmitted to the NAT gateway 638 that can make the call to public Internet 654. Metadata to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to a configuration may need to be applied to the resources implemented in the data plane VCN 618. Via a VNIC 642, the control plane VCN 616 can directly communicate with, and can thereby execute the changes, updates, or other suitable modifications to configuration to, resources implemented in the data plane VCN 618.

In some embodiments, the control plane VCN 616 and the data plane VCN 618 can be implemented in the service tenancy 619. In this case, the user, or the customer, of the system may not own or operate either the control plane VCN 616 or the data plane VCN 618. Instead, the IaaS provider may own or operate the control plane VCN 616 and the data plane VCN 618. The control plane VCN 616 and the data plane VCN 618 may be implemented in the service tenancy 619. This embodiment can enable isolation of networks that may prevent users or customers from interacting with other users', or other customers', resources. Also, this embodiment may allow users, or customers, of the system to store databases privately without needing to rely on public Internet 654 for storage.

In other embodiments, the LB subnet(s) 622 implemented in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may need this embodiment since database(s) that the customers use may be controlled by the IaaS provider and may be stored on the service tenancy 619. The service tenancy 619 may be isolated from public Internet 654.

FIG. 2 is a block diagram illustrating another example pattern of an IaaS architecture 2 according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 710 implemented in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 implemented in the control plane VCN 716. The control plane VCN 716 can be implemented in a service tenancy 719 (e.g., the service tenancy 619 of FIG. 6), and the data plane VCN 718 (e.g., the data plane VCN 618 of FIG. 6) can be implemented in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), and a control plane data tier 728 (e.g., the control plane data tier 628 of FIG. 6) that can include database (DB) subnet(s) 730 (e.g., similar to DB subnet(s) 630 of FIG. 6). The LB subnet(s) 722 implemented in the control plane DMZ tier 720 can be communicatively coupled to the app subnet(s) 726 implemented in the control plane app tier 724 and an Internet gateway 734 (e.g., the Internet gateway 634 of FIG. 6) that can be implemented in the control plane VCN 716. The app subnet(s) 726 can be communicatively coupled to the DB subnet(s) 730 implemented in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 implemented in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be implemented in a data plane app tier 746 (e.g., the data plane app tier 646 of FIG. 6). The compute instance 744 can facilitate this communication via the VNIC 742 implemented in the data plane mirror app tier 740 and the VNIC 742 implemented in the data plane app tier 746.

The Internet gateway 734 implemented in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 implemented in the control plane VCN 716. The service gateway 736 implemented in the control plane VCN 716 can be communicatively couple to cloud services 756 (e.g., cloud services 656 of FIG. 6).

In some examples, the data plane VCN 718 can be implemented in the customer tenancy 721. In this case, the IaaS provider may provide the control plane VCN 716 for a customer, and the IaaS provider may, for a customer, set up a unique, compute instance 744 that is implemented in the service tenancy 719. A compute instance 744 may allow communication between the control plane VCN 716 implemented in the service tenancy 719 and the data plane VCN 718 that is implemented in the customer tenancy 721. The compute instance 744 may allow resources provisioned in the control plane VCN 716 that is implemented in the service tenancy 719 to be deployed or otherwise used in the data plane VCN 718 that is implemented in the customer tenancy 721.

In other examples, the customer of the IaaS provider may have databases that are implemented in the customer tenancy 721. In this example, the control plane VCN 716 can include the data plane mirror app tier 740 that can include app subnet(s) 726. The data plane mirror app tier 740 can be implemented in the control plane VCN 716, but the data plane mirror app tier 740 may not be implemented in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity implemented in the control plane VCN 716. The customer may need to deploy or otherwise use resources in the data plane VCN 718 that are provisioned in the control plane VCN 716, and the data plane mirror app tier 740 can facilitate the deployment or other usage of resources of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, implemented in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be active or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 1” may be located in Region 1 and in “Region 2.” If a call to Deployment 1 is made by the service gateway 736 implemented in the control plane VCN 716 located in Region 1, the call may be transmitted to Deployment 1 in Region 1. In this example, the control plane VCN 716, or Deployment 1 in Region 1, may not be communicatively coupled to, or otherwise in communication with, Deployment 1 in Region 2.

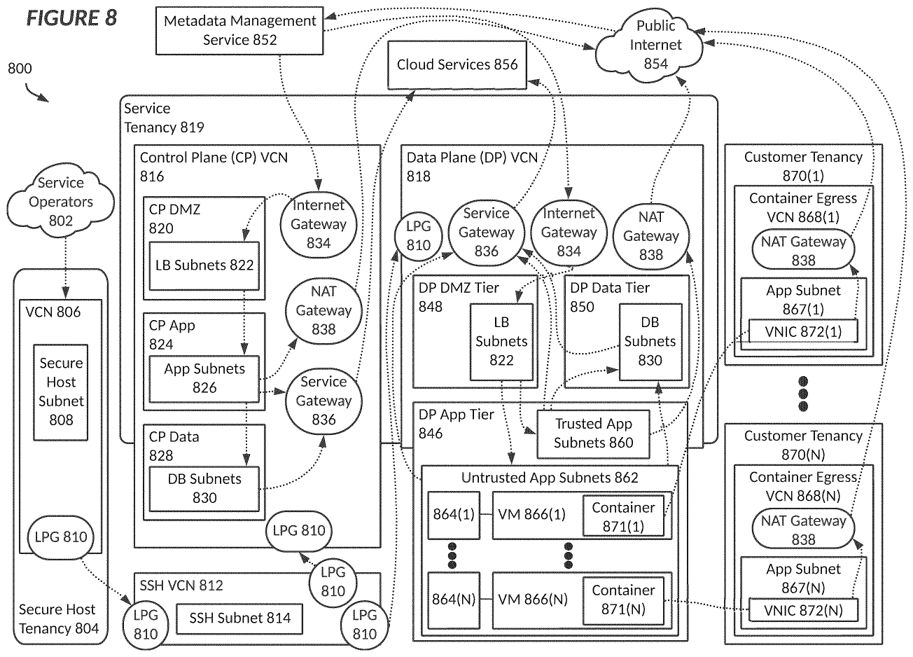

FIG. 8 is a block diagram illustrating another example pattern of an IaaS architecture 800 according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 implemented in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 implemented in the control plane VCN 816 and to a data plane VCN 818 (e.g., the data plane VCN 618 of FIG. 6) via an LPG 810 implemented in the data plane VCN 818. The control plane VCN 816 and the data plane VCN 818 can be implemented in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), and a control plane data tier 828 (e.g., the control plane data tier 628 of FIG. 6) that can include DB subnet(s) 830. The LB subnet(s) 822 implemented in the control plane DMZ tier 820 can be communicatively coupled to the app subnet(s) 826 implemented in the control plane app tier 824 and to an Internet gateway 834 (e.g., the Internet gateway 634 of FIG. 6) that can be implemented in the control plane VCN 816, and the app subnet(s) 826 can be communicatively coupled to the DB subnet(s) 830 implemented in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860, untrusted app subnet(s) 862 of the data plane app tier 846, and the Internet gateway 834 implemented in the data plane VCN 818. The trusted app subnet(s) 860 can be communicatively coupled to the service gateway 836 implemented in the data plane VCN 818, the NAT gateway 838 implemented in the data plane VCN 818, and DB subnet(s) 830 implemented in the data plane data tier 850. The untrusted app subnet(s) 862 can be communicatively coupled to the service gateway 836 implemented in the data plane VCN 818 and DB subnet(s) 830 implemented in the data plane data tier 850. The data plane data tier 850 can include DB subnet(s) 830 that can be communicatively coupled to the service gateway 836 implemented in the data plane VCN 818.

The untrusted app subnet(s) 862 can include one or more primary VNICs 864(1)-(N) that can be communicatively coupled to tenant virtual machines (VMs) 866(1)-(N). Tenant VMs 866(1)-(N) can be communicatively coupled to a respective app subnets 867(1)-(N) that can be implemented in respective container egress VCNs 868(1)-(N) that can be implemented in respective customer tenancies 870(1)-(N). Respective secondary VNICs 872(1)-(N) can facilitate communication between the untrusted app subnet(s) 862 implemented in the data plane VCN 818 and the app subnet implemented in the container egress VCNs 868(1)-(N). Container egress VCNs 868(1)-(N) can include a NAT gateway 838 that can be communicatively coupled to public Internet 854 (e.g., public Internet 654 of FIG. 6).

The Internet gateway 834 implemented in the control plane VCN 816 and implemented in the data plane VCN 818 can be communicatively coupled to a metadata management service 852 (e.g., the metadata management service 652 of FIG. 6) that can be communicatively coupled to public Internet 854. Public Internet 854 can be communicatively coupled to the NAT gateway 838 implemented in the control plane VCN 816 and implemented in the data plane VCN 818. The service gateway 836 implemented in the control plane VCN 816 and implemented in the data plane VCN 818 can be communicatively couple to cloud services 856.

In some embodiments, the data plane VCN 818 can be integrated with customer tenancies 870(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 846. Code to execute the function may be executed in the VMs 866(1)-(N), and the code may not be configured to execute anywhere else on the data plane VCN 818. VMs 866(1)-(N) may be connected to one customer tenancy 870(1). Respective containers 871(1)-(N) implemented in the VMs 866(1)-(N) may be configured to execute the code. In this case, there can be a dual isolation (e.g., the containers 871(1)-(N) executing code), where the containers 871(1)-(N) may be implemented in at least the VM 866(1)-(N) that are implemented in the untrusted app subnet(s) 862) that may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completing execution of the code, the IaaS provider may terminate or otherwise dispose of the containers 871(1)-(N).

In some embodiments, the trusted app subnet(s) 860 may execute code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be implemented in the VM 866(1)-(N) of a customer and that may execute code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

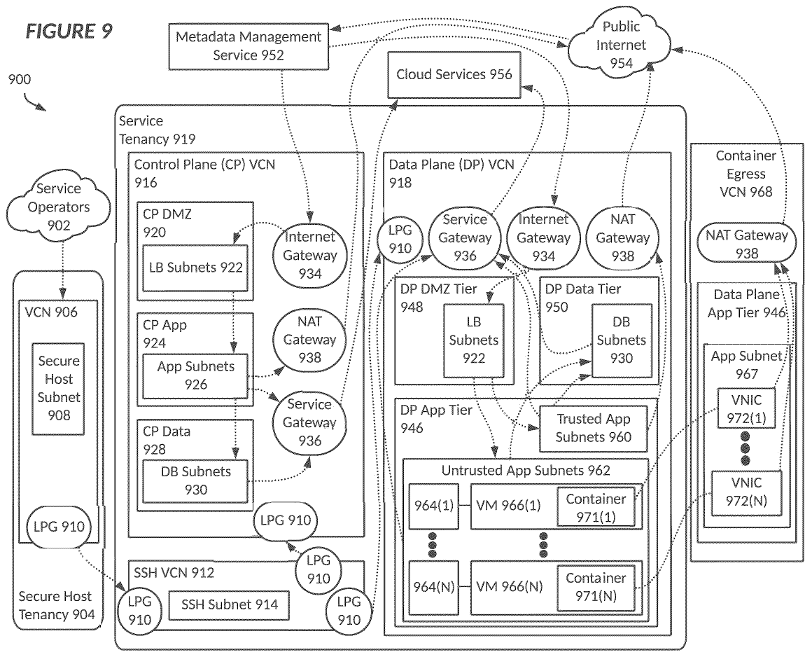

FIG. 9 is a block diagram illustrating another example pattern of an IaaS architecture 900 according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 implemented in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 implemented in the control plane VCN 916 and to a data plane VCN 918 (e.g., the data plane VCN 618 of FIG. 6) via an LPG 910 implemented in the data plane VCN 918. The control plane VCN 916 and the data plane VCN 918 can be implemented in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), and a control plane data tier 928 (e.g., the control plane data tier 628 of FIG. 6) that can include DB subnet(s) 930 (e.g., DB subnet(s) 830 of FIG. 8). The LB subnet(s) 922 implemented in the control plane DMZ tier 920 can be communicatively coupled to the app subnet(s) 926 implemented in the control plane app tier 924 and to an Internet gateway 934 (e.g., the Internet gateway 634 of FIG. 6) that can be implemented in the control plane VCN 916, and the app subnet(s) 926 can be communicatively coupled to the DB subnet(s) 930 implemented in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 implemented in the data plane VCN 918. The trusted app subnet(s) 960 can be communicatively coupled to the service gateway 936 implemented in the data plane VCN 918, the NAT gateway 938 implemented in the data plane VCN 918, and DB subnet(s) 930 implemented in the data plane data tier 950. The untrusted app subnet(s) 962 can be communicatively coupled to the service gateway 936 implemented in the data plane VCN 918 and DB subnet(s) 930 implemented in the data plane data tier 950. The data plane data tier 950 can include DB subnet(s) 930 that can be communicatively coupled to the service gateway 936 implemented in the data plane VCN 918.

The untrusted app subnet(s) 962 can include primary VNICs 964(1)-(N) that can be communicatively coupled to tenant virtual machines (VMs) 966(1)-(N) implemented within the untrusted app subnet(s) 962. Tenant VMs 966(1)-(N) can execute code in a respective container 967(1)-(N) and be communicatively coupled to an app subnet 967 that can be implemented in a data plane app tier 946 that can be implemented in a container egress VCN 968. Respective secondary VNICs 972(1)-(N) can facilitate communication between the untrusted app subnet(s) 962 implemented in the data plane VCN 918 and the app subnet 967 implemented in the container egress VCN 968. The container egress VCN 968 can include a NAT gateway 938 that can be communicatively coupled to public Internet 954 (e.g., public Internet 654 of FIG. 6).

The Internet gateway 934 implemented in the control plane VCN 916 and implemented in the data plane VCN 918 can be communicatively coupled to a metadata management service 952 (e.g., the metadata management service 652 of FIG. 6) that can be communicatively coupled to public Internet 954. Public Internet 954 can be communicatively coupled to the NAT gateway 938 implemented in the control plane VCN 916 and implemented in the data plane VCN 918. The service gateway 936 implemented in the control plane VCN 916 and implemented in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be needed for a customer of the IaaS provider if the IaaS provider cannot directly communicate with the customer (e.g., a disconnected region). The respective containers 971(1)-(N) that are implemented in the VMs 966(1)-(N) for a customer can be accessed in real-time by the customer. The containers 971(1)-(N) may be configured to make calls to respective secondary VNICs 972(1)-(N) implemented in app subnet(s) 967 of the data plane app tier 946 that can be implemented in the container egress VCN 968. The secondary VNICs 972(1)-(N) can transmit the calls to the NAT gateway 938 that may transmit the calls to public Internet 954. In this example, the containers 971(1)-(N) that can be accessed in real time by the customer can be isolated from the control plane VCN 916 and can be isolated from other entities implemented in the data plane VCN 918. The containers 971(1)-(N) may also be isolated from resources from other customers.

In other examples, the customer can use the containers 971(1)-(N) to call cloud services 956. In this example, the customer may execute code in the containers 971(1)-(N) that request a service from cloud services 956. The containers 971(1)-(N) can transmit this request to the secondary VNICs 972(1)-(N) that can transmit the request to the NAT gateway 938 that can transmit the request to public Internet 954. Public Internet 954 can transmit the request to LB subnet(s) 922 implemented in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, and 900 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. EXAMPLES OF CLOUD NETWORKS

As noted above, infrastructure as a service (IaaS) is one particular type of cloud computing service. In an IaaS model, customers can build their own customizable virtual or overlay networks and deploy customer resources over on-demand, scalable computing resources of CI.

The CI may comprise interconnected high-performance compute resources including various host machines, memory resources, and network resources that form a physical network, which is also referred to as a substrate network or an underlay network. The resources in CI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)) Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CI is physically hosted in one or more data centers in one or more regions around the world. The CI may include components in the physical or substrate network and virtualized components (e.g., virtual networks, compute instances, virtual machines, etc.) that are in a virtual network built on top of the physical network components. In certain embodiments, the CI is organized and hosted in realms, regions, and availability domains.

When a customer subscribes to an IaaS service, resources from CI are provisioned for the customer and associated with the customer's tenancy. The customer can use these provisioned resources to build private networks and deploy resources on these networks. The customer networks that are hosted in the cloud by the CI are referred to as virtual cloud networks (VCNs). A customer can set up one or more virtual cloud networks (VCNs) using CI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with publicly accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints. CI thus offers high-performance compute resources and storage capacity in flexible virtual networks that are securely accessible from various networked locations such as from a customer's on-premises network.

The CP may provide various services using the CI. In some instances, customers of CI may themselves act like service providers and provide services using CI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN, and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN, and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

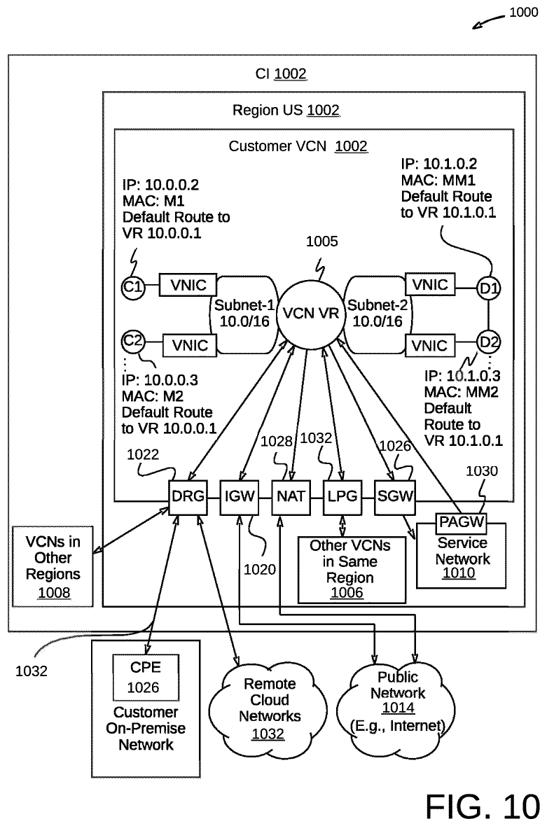

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 10. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP), and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane.

A customer may create one or more VCNs using resources hosted by CI. A compute instance deployed on a customer VCN may communicate with different endpoints. These endpoints can include endpoints that are hosted by CI and endpoints outside CI.

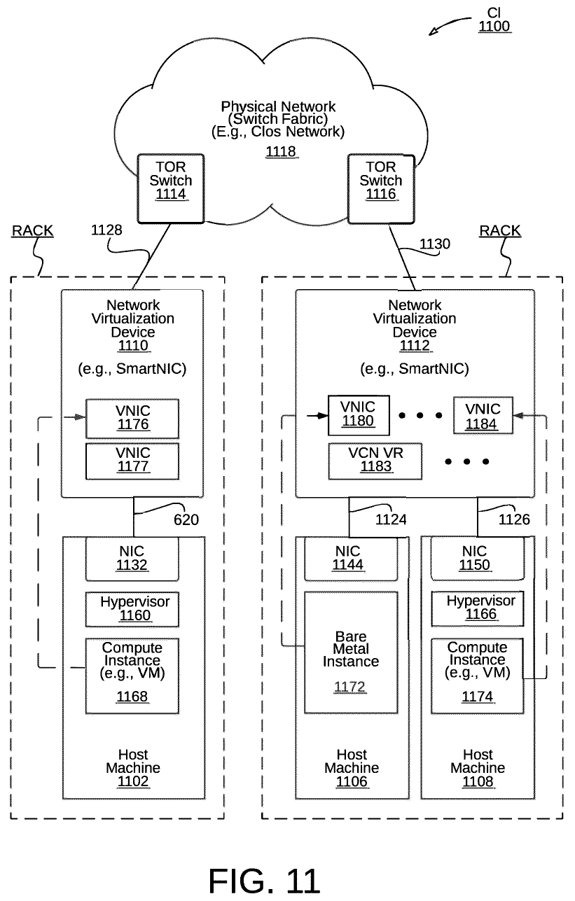

Various different architectures for implementing cloud-based service using CI are depicted in FIGS. 10-11, and are described below. FIG. 10 is a high-level diagram of a distributed environment 1000 showing an overlay or customer VCN hosted by CI according to certain embodiments. The distributed environment depicted in FIG. 10 includes multiple components in the overlay network. Distributed environment 1000 depicted in FIG. 10 is merely an example and is not intended to unduly limit the scope of claimed embodiments. Many variations, alternatives, and modifications are possible. For example, in some implementations, the distributed environment depicted in FIG. 10 may have more or fewer systems or components than those shown in FIG. 10, may combine two or more systems, or may have a different configuration or arrangement of systems.

As shown in the example depicted in FIG. 10, distributed environment 1000 comprises CI 1001 that provides services and resources that customers can subscribe to and use to build their virtual cloud networks (VCNs). In certain embodiments, CI 1001 offers IaaS services to subscribing customers. The data centers within CI 1001 may be organized into one or more regions. One example region “Region US” 1002 is shown in FIG. 10. A customer has configured a customer VCN c/o Oracle International Corporation for region 1002. The customer may deploy various compute instances on VCN 1004, where the compute instances may include virtual machines or bare metal instances. Examples of instances include applications, database, load balancers, and the like.

In the embodiment depicted in FIG. 10, customer VCN 1004 comprises two subnets, namely, “Subnet-1” and “Subnet-2”, each subnet with its own CIDR IP address range. In FIG. 10, the overlay IP address range for Subnet-1 is 10.0/16 and the address range for Subnet-2 is 10.1/16. A VCN Virtual Router 1005 represents a logical gateway for the VCN that enables communications between subnets of the VCN 1004, and with other endpoints outside the VCN. VCN VR 1005 is configured to route traffic between VNICs in VCN 1004 and gateways associated with VCN 1004. VCN VR 1005 provides a port for each subnet of VCN 1004. For example, VR 1005 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CI 1001. A compute instance participates in a subnet via a VNIC associated with the compute instance. For example, as shown in FIG. 10, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 10, compute instance C1 has an overlay IP address of 10.0.0.2 and a MAC address of M1, while compute instance C2 has a private overlay IP address of 10.0.0.3 and a MAC address of M2. Each compute instance in Subnet-1, including compute instances C1 and C2, has a default route to VCN VR 1005 using IP address 10.0.0.1, which is the IP address for a port of VCN VR 1005 for Subnet-1.

Subnet-2 can have multiple compute instances deployed on it, including virtual machine instances and/or bare metal instances. For example, as shown in FIG. 10, compute instances D1 and D2 are part of Subnet-2 via VNICs associated with the respective compute instances. In the embodiment depicted in FIG. 10, compute instance D1 has an overlay IP address of 10.1.0.2 and a MAC address of MM1, while compute instance D2 has a private overlay IP address of 10.1.0.3 and a MAC address of MM2. Each compute instance in Subnet-2, including compute instances D1 and D2, has a default route to VCN VR 1005 using IP address 10.1.0.1, which is the IP address for a port of VCN VR 1005 for Subnet-2.

VCN 1004 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 1004 can communicate with various different endpoints. These endpoints may include endpoints that are hosted by CI 1001 and endpoints outside CI 1001. Endpoints that are hosted by CI 1001 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 1006 or 1010, communications between a compute instance in Subnet-1 and an endpoint in service network 1010 in the same region); or an endpoint in a VCN in a different region (e.g., communications between a compute instance in Subnet-1 and an endpoint in a VCN in a different region 1008). A compute instance in a subnet hosted by CI 1001 may also communicate with endpoints that are not hosted by CI 1001 (i.e., are outside CI 1001). These outside endpoints include endpoints in the customer's on-premises network 1016, endpoints within other remote cloud hosted networks 1018, public endpoints 1014 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 10 wants to send a packet to compute instance D1 in Subnet-2, the packet is first processed by the VNIC associated with compute instance C1. The VNIC associated with compute instance C1 is configured to route the packet to the VCN VR 1005 using default route or port 10.0.0.1 of the VCN VR. VCN VR 1005 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 1004 to an endpoint that is outside VCN 1004, the communication is facilitated by the VNIC associated with the source compute instance, VCN VR 1005, and gateways associated with VCN 1004. One or more types of gateways may be associated with VCN 1004. A gateway is an interface between a VCN and another endpoint, where another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 1004. The packet may be first processed by the VNIC associated with source compute instance C1. The VNIC processing determines that the destination for the packet is outside the Subnet-1 of C1. The VNIC associated with C1 may forward the packet to VCN VR 1005 for VCN 1004. VCN VR 1005 then processes the packet and as part of the processing, based upon the destination for the packet, determines a particular gateway associated with VCN 1004 as the next hop for the packet. VCN VR 1005 may then forward the packet to the particular identified gateway. For example, if the destination is an endpoint within the customer's on-premise network, then the packet may be forwarded by VCN VR 1005 to Dynamic Routing Gateway (DRG) gateway 1022 configured for VCN 1004. The packet may then be forwarded from the gateway to a next hop to facilitate communication of the packet to it final intended destination.

Various different types of gateways may be configured for a VCN. Examples of gateways that may be configured for a VCN are depicted in FIG. 10 and described below. As shown in the embodiment depicted in FIG. 10, a Dynamic Routing Gateway (DRG) 1022 may be added to or be associated with customer VCN 1004 and provides a path for private network traffic communication between customer VCN 1004 and another endpoint, where another endpoint can be the customer's on-premise network 1016, a VCN 1008 in a different region of CI 1001, or other remote cloud networks 1018 not hosted by CI 1001. Customer on-premise network 1016 may be a customer network or a customer data center built using the customer's resources. Access to customer on-premise network 1016 is generally very restricted. For a customer that has both a customer on-premise network 1016 and one or more VCNs 1004 deployed or hosted in the cloud by CI 1001, the customer may want their on-premise network 1016 and their cloud based VCN 1004 to be able to communicate with each other. This enables a customer to build an extended hybrid environment encompassing the customer's VCN 1004 hosted by CI 1001 and their on-premises network 1016. DRG 1022 enables this communication. To enable such communications, a communication channel 1024 is set up where one endpoint of the channel is in customer on-premise network 1016 and the other endpoint is in CI 1001 and connected to customer VCN 1004. Communication channel 1024 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 1016 that forms one end point for communication channel 1024 is referred to as the customer premise equipment (CPE), such as CPE 1026 depicted in FIG. 10. On the CI 1001 side, the endpoint may be a host machine executing DRG 1022.

In certain embodiments, a Remote Peering Connection (RPC) can be added to a DRG, which allows a customer to peer one VCN with another VCN in a different region. Using such an RPC, customer VCN 1004 can use DRG 1022 to connect with a VCN 1008 in another region. DRG 1022 may also be used to communicate with other remote cloud networks 1018, not hosted by CI 1001 such as a Microsoft Azure cloud, Amazon AWS cloud, and others.

As shown in FIG. 10, an Internet Gateway (IGW) 1020 may be configured for customer VCN 1004 the enables a compute instance on VCN 1004 to communicate with public endpoints 1014 accessible over a public network such as the Internet. IGW 1020 is a gateway that connects a VCN to a public network such as the Internet. IGW 1020 enables a public subnet (where the resources in the public subnet have public overlay IP addresses) within a VCN, such as VCN 1004, direct access to public endpoints 1012 on a public network 1014 such as the Internet. Using IGW 1020, connections can be initiated from a subnet within VCN 1004 or from the Internet.

A Network Address Translation (NAT) gateway 1028 can be configured for customer's VCN 1004 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 1004, with private access to public endpoints on the Internet. In NAT gateways, connections can be initiated only from the private subnet to the public Internet and not from the Internet to the private subnet.

In certain embodiments, a Service Gateway (SGW) 1026 can be configured for customer VCN 1004 and provides a path for private network traffic between VCN 1004 and supported services endpoints in a service network 1010. In certain embodiments, service network 1010 may be provided by the CP and may provide various services. An example of such a service network is Oracle's Services Network, which provides various services that can be used by customers. For example, a compute instance (e.g., a database system) in a private subnet of customer VCN 1004 can back up data to a service endpoint (e.g., Object Storage) without needing public IP addresses or access to the Internet. In certain embodiments, a VCN can have only one SGW, and connections can only be initiated from a subnet within the VCN and not from service network 1010. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 1026 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 1032 is a gateway that can be added to customer VCN 1004 and enables VCN 1004 to peer with another VCN in the same region. Peering means that the VCNs communicate using private IP addresses, without the traffic traversing a public network such as the Internet or without routing the traffic through the customer's on-premises network 1016. In preferred embodiments, a VCN has a separate LPG for each peering it establishes. Local Peering or VCN Peering is a common practice used to establish network connectivity between different applications or infrastructure management functions.

Service providers, such as providers of services in service network 1010, may provide access to services using different access models. According to a public access model, services may be exposed as public endpoints that are publicly accessible by compute instance in a customer VCN via a public network such as the Internet and or may be privately accessible via SGW 1026. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 1030 is a gateway resource that can be attached to a service provider VCN (e.g., a VCN in service network 1010) that acts as an ingress/egress point for all traffic from/to customer subnet private endpoints. PAGW 1030 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 1030 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 1032 and the PE in the customer's VCN.

A customer can control routing in a VCN at the subnet level, so the customer can specify which subnets in the customer's VCN, such as VCN 1004, use each gateway. A VCN's route tables are used to decide if traffic is allowed out of a VCN through a particular gateway. For example, in a particular instance, a route table for a public subnet within customer VCN 1004 may send non-local traffic through IGW 1020. The route table for a private subnet within the same customer VCN 1004 may send traffic destined for CP services through SGW 1026. All remaining traffic may be sent via the NAT gateway 1028. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked, and the response is automatically allowed without an explicit security list rule for the response traffic) or stateless.

Access from a customer VCN (i.e., by a resource or compute instance deployed on VCN 1004) can be categorized as public access, private access, or dedicated access. Public access refers to an access model where a public IP address or a NAT is used to access a public endpoint. Private access enables customer workloads in VCN 1004 with private IP addresses (e.g., resources in a private subnet) to access services without traversing a public network such as the Internet. In certain embodiments, CI 1001 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CI may offer dedicated public access using technologies such as FastConnect public peering where customer on-premises instances can access one or more services in a customer VCN using a FastConnect connection and without traversing a public network such as the Internet. CI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CI and its services. FastConnect provides an easy, elastic, and economical way to create a dedicated and private connection with higher bandwidth options and a more reliable and consistent networking experience when compared to Internet-based connections.

FIG. 10 and the accompanying description above describes various virtualized components in an example virtual network. As described above, the virtual network is built on the underlying physical or substrate network. FIG. 11 depicts a simplified architectural diagram of the physical components in the physical network within CI 1100 that provide the underlay for the virtual network according to certain embodiments. As shown, CI 1100 provides a distributed environment comprising components and resources (e.g., compute, memory, and networking resources) provided by a cloud service provider (CP). These components and resources are used to provide cloud services (e.g., IaaS services) to subscribing customers, i.e., customers that have subscribed to one or more services provided by the CP. Based upon the services subscribed to by a customer, a subset of resources (e.g., compute, memory, and networking resources) of CI 1100 are provisioned for the customer. Customers can then build their own cloud-based (i.e., CI-hosted) customizable and private virtual networks using physical compute, memory, and networking resources provided by CI 1100. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CI 1100 provides infrastructure and a set of complementary cloud services that enable customers to build and run a wide range of applications and services in a highly available hosted environment.

In the example embodiment depicted in FIG. 11, the physical components of CI 1100 include one or more physical host machines or physical servers (e.g., 1102, 1106, 1108), network virtualization devices (NVDs) (e.g., 1110, 1112), top-of-rack (TOR) switches (e.g., 1114, 1116), and a physical network (e.g., 1118), and switches in physical network 1118. The physical host machines or servers may host and execute various compute instances that participate in one or more subnets of a VCN. The compute instances may include virtual machine instances, and bare metal instances. For example, the various compute instances depicted in FIG. 10 may be hosted by the physical host machines depicted in FIG. 11. The virtual machine compute instances in a VCN may be executed by one host machine or by multiple different host machines. The physical host machines may also host virtual host machines, container-based hosts or functions, and the like. The VNICs and VCN VR depicted in FIG. 10 may be executed by the NVDs depicted in FIG. 11. The gateways depicted in FIG. 10 may be executed by the host machines and/or by the NVDs depicted in FIG. 11.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 11, host machines 1102 and 1108 execute hypervisors 1160 and 1166, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 11, hypervisor 1160 may sit on top of the OS of host machine 1102 and enables the computing resources (e.g., processing, memory, and networking resources) of host machine 1102 to be shared between compute instances (e.g., virtual machines) executed by host machine 1102. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 11 may have the same or different types of hypervisors.

A compute instance can be a virtual machine instance or a bare metal instance. In FIG. 11, compute instances 1168 on host machine 1102 and 1174 on host machine 1108 are examples of virtual machine instances. Host machine 1106 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 11, host machine 1102 executes a virtual machine compute instance 1168 that is associated with VNIC 1176, and VNIC 1176 is executed by NVD 1110 connected to host machine 1102. As another example, bare metal instance 1172 hosted by host machine 1106 is associated with VNIC 1180 that is executed by NVD 1112 connected to host machine 1106. As yet another example, VNIC 1184 is associated with compute instance 1174 executed by host machine 1108, and VNIC 1184 is executed by NVD 1112 connected to host machine 1108.

For compute instances hosted by a host machine, an NVD connected to that host machine also executes VCN VRs corresponding to VCNs of which the compute instances are members. For example, in the embodiment depicted in FIG. 11, NVD 1110 executes VCN VR 1177 corresponding to the VCN of which compute instance 1168 is a member. NVD 1112 may also execute one or more VCN VRs 1183 corresponding to VCNs corresponding to the compute instances hosted by host machines 1106 and 1108.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 11, host machine 1102 is connected to NVD 1110 using link 1120 that extends between a port 1134 provided by a NIC 1132 of host machine 1102 and between a port 1136 of NVD 1110. Host machine 1106 is connected to NVD 1112 using link 1124 that extends between a port 1146 provided by a NIC 1144 of host machine 1106 and between a port 1148 of NVD 1112. Host machine 1108 is connected to NVD 1112 using link 1126 that extends between a port 1152 provided by a NIC 1150 of host machine 1108 and between a port 1154 of NVD 1112.

The NVDs are in turn connected via communication links to top-of-the-rack (TOR) switches, which are connected to physical network 1118 (also referred to as the switch fabric). In certain embodiments, the links between a host machine and an NVD, and between an NVD and a TOR switch are Ethernet links. For example, in FIG. 11, NVDs 1110 and 1112 are connected to TOR switches 1114 and 1116, respectively, using links 1128 and 1130. In certain embodiments, the links 1120, 1124, 1126, 1128, and 1130 are Ethernet links. The collection of host machines and NVDs that are connected to a TOR is sometimes referred to as a rack.

Physical network 1118 provides a communication fabric that enables TOR switches to communicate with each other. A communication fabric, also called network fabric or fabric, refers to a physical network structure that includes a set of interconnected switches that provide multiple redundant pathways for data flow between a set of computing devices. A fabric enables high-throughput, low-latency communication through structured, multi-path routing. A fabric has a topology that defines a physical layout and arrangement of the set of interconnected switches and links. The physical layout and arrangement of the set of interconnected switches and links define pathways for data to flow across the fabric. In an embodiment, physical network 1118 can be a multi-tiered network. In certain implementations, physical network 1118 is a multi-tiered Clos network of switches, with TOR switches 1114 and 1116 representing the leaf level nodes of the multi-tiered and multi-node physical switching network 1118. Example network fabrics employing different network topologies, such as a Clos topology, are further described below in the Section titled “Example Network Fabrics.”

### 10. EXAMPLE NETWORK FABRICS

Computing components located in the various racks of a data center are interconnected to one another by fabric. The term “network fabric” or “fabric” generally refers to a physical network structure that includes a set of interconnected switches that provide multiple redundant pathways for data flow between a set of computing devices. A fabric enables high-throughput, low-latency communication through structured, multi-path routing.

A fabric is associated with a topology that defines a physical layout and arrangement of the set of interconnected switches and links. The physical layout and arrangement of the set of interconnected switches and links define pathways for data to flow across the fabric. An example network topology is multi-tiered Clos topology. A multi-tiered Clos topology is a type of non-blocking, multistage or multi-tiered switching network topology, where the number of stages or tiers can be two, three, four, five, etc. A Clos network with “n” stages may be referred to as a “n” tiered network. Each switch in “tier n” is connected to each switch in “tier n+1.” In a 2-tier spine, t1 may be referred to a leaf layer, and t2 may be referred to as a spine layer. The spine layer can server as a high-speed backbone, interacting with the leaf layer.

A fabric can include different groups of switches and clients, referred to as “fabric groups” and “client groups,” arranged in various variations or arrangements of network topologies. Each tier of the fabric includes one or more fabric groups. The leaf tier includes one or more client groups (e.g., computing servers, GPU servers, and/or end devices). A “role” of a fabric group is associated with the tier of the fabric group. For example, a role of a fabric group in t1 may be “leaf”; and a role of a fabric group in t2 may be “spine.”

Each fabric group has a defined number of switches. Each switch has one or more south-facing ports, also called “downlinks,” and one or more north-facing ports, also called “uplinks.” The south-facing ports of switches in a fabric group of an upper tier may be connected to the north-facing ports of switches in a fabric group of a lower tier.

The configuration of connections between switches of fabric groups of adjacent tiers may be referred to as “linking configurations” or “linking rules.” Examples of linking configurations include a full mesh configuration, or a partial mesh configuration. In a full mesh configuration, every south-facing port of switches of an upper fabric group is directly connected to every north-facing port of switches of a lower fabric group. The non-blocking configuration allows connections to be made between switches in adjacent tiers without interference from currently established connections. Various cablings options may be used to implement the links, such as Active Optical Connectors (AOCs); high-speed optical transceivers that uses Coarse Wavelength Division Multiplexing (CWDM); and/or high-speed, hot-pluggable, low-power-dissipation optical transceivers.

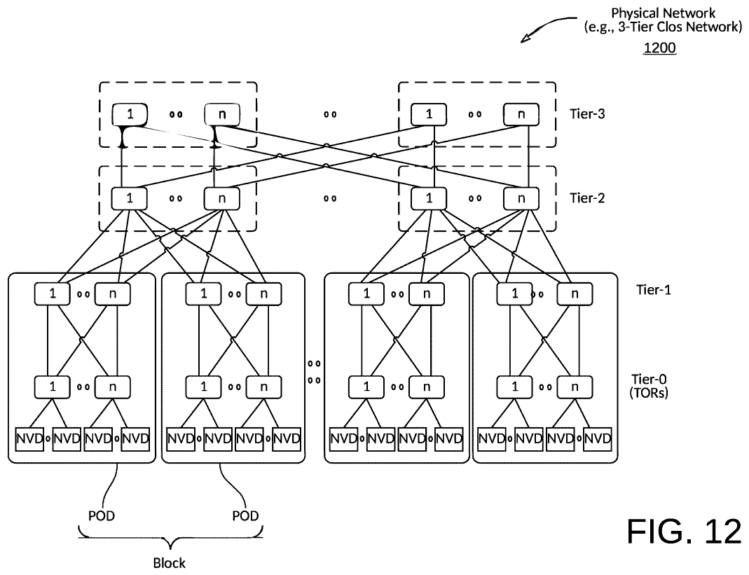

FIG. 12 depicts a simplified block diagram of a physical network 1200 structured as a Clos network according to certain embodiments. The embodiment depicted in FIG. 12 is a 3-tiered network comprising tiers 1, 2, and 3. The TOR switches represent Tier-0 switches in the Clos network. One or more NVDs are connected to the TOR switches. Tier-0 switches are also referred to as edge devices of the physical network. The Tier-0 switches are connected to Tier-1 switches (also referred to as leaf switches). In the embodiment depicted in FIG. 12, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1000 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In an embodiment, a single site implements multiple networks, each implemented by one or more network fabrics. Each network in a site may serve a different purpose, such as a front-end network, a back-end network, a management network, and/or other networks. Each network fabric in a site may be implemented using a different network topology or a different combination of network topologies.

As examples, a compute network fabric architecture (CNFA) is configured to connect with non-network racks (compute, storage, service enclave, etc.) within a datacenter. CNFA may be implemented as a 3-tier Clos network. A junction network fabric architecture (JNFA) is configured to connect with network device roles, including: CNFAs; internet gateways; dedicated private connections to on-premise datacenters of customers; and backbone devices. JNFA may be implemented as a 2-tier Clos network. A management network fabric architecture (MNFA) is configured to connect with management devices. In an example, a site includes a CNFA, JNDA, and MNFA. The CNFA may include multiple (e.g., six) blocks. For external connectivity, a subset of t2 blocks (e.g., one t2 block) of the CNFA in a site is dedicated to connecting to t1 switches of the JNFA (rather than t3 super-spine switches of the CNFA, as described above). Further, one or more t1 switches of the JNFA are dedicated to connecting to t1 switches of the MNFA.

As further examples, performance network fabric architectures (PNFA) may be used. PNFA provides connectivity for cluster networks, such as high-performance computer (HPC) networks, high-performance database platform networks, and GPU networks. PNFA enables fine-grained traffic engineering that supports Quality of Service (QoS), which is a set of technologies that manage network traffic to prioritize critical applications. PNFA supports RDMA over Converged Ethernet (e.g., RoCE v1 and/or ROCEv2), Virtual eXtensible Local-Area Network (VXLAN), dynamic load balancing (DLB), Dot1x, etc. Different variants of PNFA have different numbers of tiers, e.g., two, three. In an example, a site may include a CNFA and a PNFA. “RDMA” or “Remote Direct Memory Access” generally refers to a technology that allows computing devices to access each other's memory directly without using the operating system.

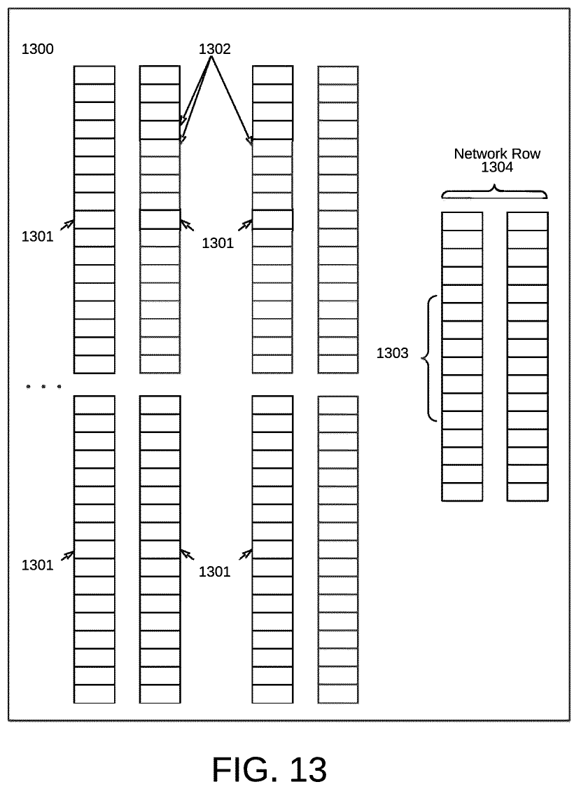

A fabric topology is implemented by physical racks of switches. In an embodiment, each block of switches in a network fabric is implemented in separate racks within a datacenter. FIG. 13 depicts a data hall 1300 containing rows of compute racks and network racks, with the network racks implementing a network fabric, according to certain embodiments. The leaf block racks 1301 may be located on the data hall floor adjacent to host-containing racks 1302, effectively providing the data hall with functionality of an intermediate distribution frame (IDF). The spine block racks 1303 may be located in a network row 1304 in the data hall 1300, effectively providing the data hall with functionality of a main distribution frame (MDF). Several data halls can be combined to provide a data center with a larger capacity.

### 9. HARDWARE OVERVIEW

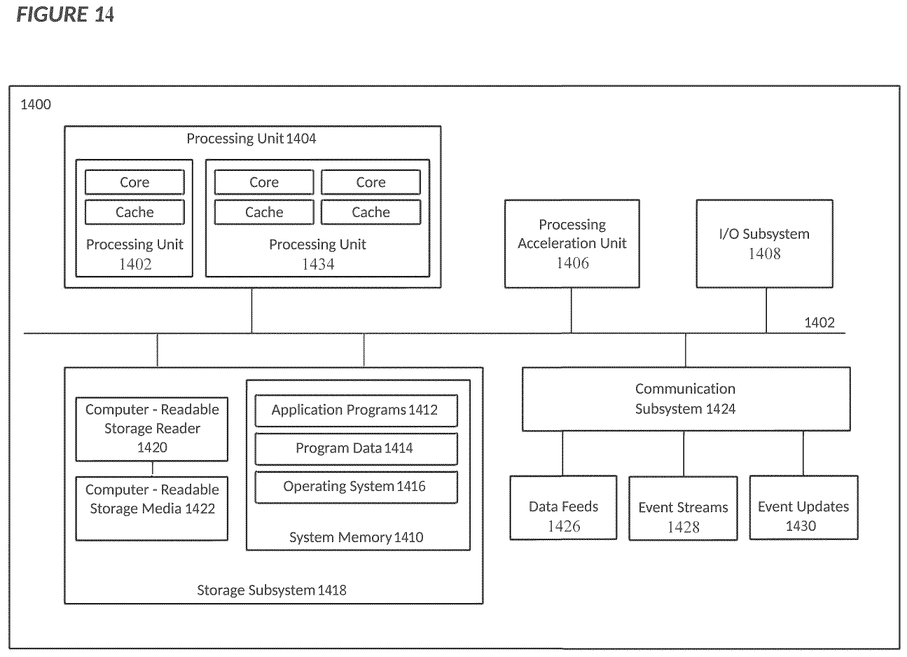

FIG. 14 illustrates an example computer system 1400. An embodiment of the disclosure may be implemented upon the computer system 1400. As shown in FIG. 14, computer system 1400 includes a processing unit 1404 that communicates with peripheral subsystems via a bus subsystem 1402. These peripheral subsystems may include a processing acceleration unit 1406, an I/O subsystem 1408, a storage subsystem 1418, and a communications subsystem 1424. Storage subsystem 1418 includes tangible computer-readable storage media 1422, computer-readable storage reader 1420 and a system memory 1410.

Bus subsystem 1402 provides a mechanism for letting the various components and subsystems of computer system 1400 to communicate with other components and subsystems as intended. Although bus subsystem 1402 is shown schematically as a single bus, alternative embodiments of the bus subsystem may utilize multiple buses. Bus subsystem 1402 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 1404 controls the operation of computer system 1400. Processing unit 1404 can be implemented as one or more integrated circuits (e.g., a conventional microprocessor or microcontroller). One or more processors may be implemented in processing unit 1404. These processors may include single core or multicore processors. In certain embodiments, processing unit 1404 may be implemented as one or more independent sub processing units 1432 and/or 1434 with single or multicore processors implemented in one or more processing units. In other embodiments, processing unit 1404 may also be implemented as a quad-core processing unit formed by integrating two dual-core processors into a single chip.

In various embodiments, processing unit 1404 can execute a variety of programs in response to program code and can maintain multiple concurrently executing programs or processes. At any given time, the program code to be executed can be wholly or partially implemented in processing unit 1404 and/or in storage subsystem 1418. Through suitable programming, processing unit 1404 can provide various functionalities described above. Computer system 1400 may additionally include a processing acceleration unit 1406 that can include a digital signal processor (DSP), a special-purpose processor, and/or the like.

I/O subsystem 1408 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1400 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1400 may comprise a storage subsystem 1418 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1404, provide the functionality described above. Storage subsystem 1418 may also provide a repository for storing data used in accordance with the present disclosure.

As depicted in the example in FIG. 14, storage subsystem 1418 can include various components, including a system memory 1410, computer-readable storage media 1422, and a computer readable storage media reader 1420. System memory 1410 may store program instructions, such as application programs 1412, that are loadable and executable by processing unit 1404. System memory 1410 may also store data, such as program data 1414, that is used during the execution of the instructions and/or data that is generated during the execution of the program instructions. Various programs may be loaded into system memory 1410 including, but not limited to, client applications, Web browsers, mid-tier applications, relational database management systems (RDBMS), virtual machines, containers, etc.

System memory 1410 may also store an operating system 1416. Examples of operating system 1416 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1400 executes one or more virtual machines, the virtual machines along with their guest operating systems (GOSs) may be loaded into system memory 1410 and executed by one or more processors or cores of processing unit 1404.

System memory 1410 can come in different configurations depending upon the type of computer system 1400. For example, system memory 1410 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1410 may include a basic input/output system (BIOS) including basic routines that help to transfer information between elements within computer system 1400 such as during start-up.

Computer-readable storage media 1422 may represent remote, local, fixed, and/or removable storage devices plus storage media for temporarily and/or more permanently including and storing computer-readable information for use by computer system 1400, including instructions executable by processing unit 1404 of computer system 1400.

Computer-readable storage media 1422 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1400.

Machine-readable instructions executable by one or more processors or cores of processing unit 1404 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some embodiments, communications subsystem 1424 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1424 can provide wired network connectivity (e.g., Ethernet) in addition to or instead of a wireless interface.

In some embodiments, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive data feeds 1426 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1424 may be configured to receive data in the form of continuous data streams. The continuous data streams may include event streams 1428 of real-time events and/or event updates 1430 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in FIG. 14 is intended as a non-limiting example. Many other configurations having more or fewer components than the system depicted in FIG. 14 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 10. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
receiving telemetry data from a plurality of sensors in a workload execution enclave comprising a first plurality of computing devices configured to execute workloads;
causing transmission of the telemetry data from the workload execution enclave to a monitoring application in a cloud management enclave, wherein the monitoring application is configured to execute one or more monitoring operations in relation to the workload execution enclave based on the telemetry data, wherein the cloud management enclave includes a second plurality of computing devices configured to execute cloud management services;
processing the telemetry data at the cloud management enclave to generate processed telemetry data;
causing transmission of the processed telemetry data from the cloud management enclave to a facility control system in a facilities management enclave, wherein the facilities management enclave includes a third plurality of computing devices configured to execute the facility control system; and
regulating, by the facility control system, one or more facilities associated with the workload execution enclave based on the processed telemetry data,
wherein the method is performed by at least one device including a hardware processor.

2. The method of claim 1, wherein the workload execution enclave is restricted from transmitting one or more types of communications directly to the facilities management enclave.

3. The method of claim 1, wherein the workload execution enclave comprises a customer enclave that is managed by a cloud provider or colo provider and configured to execute the workloads for a customer associated with the customer enclave.

4. The method of claim 1, wherein each of the workload execution enclave, the cloud management enclave and the facilities management enclave has at least one network fabric, and no network fabric crosses multiple enclaves.

5. The method of claim 1, wherein a first peering connection is made between the workload execution enclave and the cloud management enclave, a second peering connection is made between the cloud management enclave and the facilities management enclave, and no peering connection is established between the workload execution enclave and the facilities management enclave.

6. The method of claim 1, wherein a computing device in the workload execution enclave executing the workloads is associated with a sensor and a baseboard management controller, wherein the baseboard management controller receives the telemetry data from the sensor and transmits the telemetry data to the monitoring application.

7. The method of claim 6, wherein a connection is established in the workload execution enclave for external communication with the baseboard management controller, and no connection is established in the workload execution enclave for external communication with the sensor or the computing device.

8. The method of claim 1, wherein the workload execution enclave implements one or more security policies that allow egress traffic and prohibit ingress traffic.

9. The method of claim 1, wherein the monitoring application filters telemetry data by identifying state changes in the telemetry data requiring control system notification and suppressing redundant updates in the telemetry data.

10. The method of claim 9, wherein the monitoring application enriches the telemetry data with location data for providing physical context for facility control system responses.

11. The method of claim 10, wherein enriching the telemetry data with the location data comprises:
mapping a sensor or computing device to a physical location within a data center; and
transmitting processed telemetry data that includes information identifying the physical location.

12. The method of claim 10, wherein enriching the telemetry data with the location data comprises:
mapping a sensor or computing device to relevant facilities within a data center; and
transmitting processed telemetry data that includes information identifying the relevant facilities.

13. The method of claim 1, wherein the monitoring application in the cloud management enclave possesses one or more credentials for transmitting data to the facility control system in the facilities management enclave, and components in the workload execution enclave lack any credentials for transmitting data to the facility control system in the facilities management enclave.

14. The method of claim 1, wherein the telemetry data comprises coolant leak detection telemetry data collected by leak sensors coupled to the first plurality of computing devices in the workload execution enclave.

15. The method of claim 1, wherein the workload execution enclave and the cloud management enclave operate under control of different entities, the workload execution enclave operating under control of a cloud customer and the cloud management enclave operating under control of a cloud services provider.

16. The method of claim 1, wherein the one or more facilities includes a liquid cooling system; the telemetry data comprises power telemetry data collected by sensors associated with at least one graphics processing unit (GPU); and the operations further comprise:
determining that an increase in power consumption at the at least one GPU satisfies a trigger criterion; and
instructing the facility control system to increase cooling for the at least one GPU when the trigger criterion is satisfied.

17. The method of claim 16, wherein increasing cooling for the at least one GPU comprises increasing cooling of chillers that pump liquid coolant to cold plates of the at least one GPU.

18. The method of claim 16, wherein the operations further comprise analyzing power consumption to determine the trigger criterion.

19. One or more non-transitory computer readable media comprising instructions that, when executed by one or more hardware processors, cause performance of operations comprising:
receiving telemetry data from a plurality of sensors in a workload execution enclave comprising a first plurality of computing devices configured to execute workloads;
causing transmission of the telemetry data from the workload execution enclave to a monitoring application in a cloud management enclave, wherein the monitoring application is configured to execute one or more monitoring operations in relation to the workload execution enclave based on the telemetry data, wherein the cloud management enclave includes a second plurality of computing devices configured to execute cloud management services;
processing the telemetry data at the cloud management enclave to generate processed telemetry data;
causing transmission of the processed telemetry data from the cloud management enclave to a facility control system in a facilities management enclave, wherein the facilities management enclave includes a third plurality of computing devices configured to execute the facility control system; and
regulating, by the facility control system, one or more facilities associated with the workload execution enclave based on the processed telemetry data.

20. A system comprising:
one or more hardware processors;
one or more non-transitory computer-readable media; and
program instructions stored on the one or more non-transitory computer-readable media which, when executed by the one or more hardware processors, cause the system to perform operations comprising:
receiving telemetry data from a plurality of sensors in a workload execution enclave comprising a first plurality of computing devices configured to execute workloads;
causing transmission of the telemetry data from the workload execution enclave to a monitoring application in a cloud management enclave, wherein the monitoring application is configured to execute one or more monitoring operations in relation to the workload execution enclave based on the telemetry data, wherein the cloud management enclave includes a second plurality of computing devices configured to execute cloud management services;
processing the telemetry data at the cloud management enclave to generate processed telemetry data;
causing transmission of the processed telemetry data from the cloud management enclave to a facility control system in a facilities management enclave, wherein the facilities management enclave includes a third plurality of computing devices configured to execute the facility control system; and
regulating, by the facility control system, one or more facilities associated with the workload execution enclave based on the processed telemetry data.
